(19) United States
(12) Patent Application Publication
(10) Pub. No.: US 2026/0263939 A1
(43) Pub. Date: Sep. 10, 2026

(54) SYSTEM AND METHOD FOR MANAGING AVATARS FOR USE IN MULTIPLE 3D RENDERING PLATFORMS

(71) Applicant: Cross Game Play LLC, Dacula, GA (US)

(72) Inventors: Kelvin John Troy, Dublin (IE); John Michael O'Connor, Down (IE)

(21) Appl. No.: 19/660,729

(22) Filed: Apr. 28, 2026

Related U.S. Application Data
(63) Continuation-in-part of application No. 19/306,300, filed on Aug. 21, 2025.
Application No. 19/306,300 is a continuation of application No. 18/323,529, filed on May 25, 2023, now Pat. No. 12,420,199.

(51) Int. Cl. A63F 13/63; A63F 13/52; A63F 13/60; A63F 13/79; G06F 8/20; G06F 9/54; G06T 15/00

(52) U.S. Cl. CPC A63F 13/63; A63F 13/52; A63F 13/60; A63F 13/79; G06F 8/20; G06F 9/547; G06T 15/005; A63F 2300/538; A63F 2300/5553; A63F 2300/66

(57) ABSTRACT

Systems and methods are disclosed for destination-controlled runtime enforcement for portable digital assets across generative world instances. A continuity capsule is generated, comprising asset commitments and policy constraints. For a specific, dynamically instantiated destination context, a capability profile is obtained. A deterministic projection maps asset semantics into a destination-compatible form. A destination acceptance artifact is generated, binding a commitment to the projected form to the specific world instance and a freshness context. Runtime enforcement gates, integrated into engine subsystems, permit operations when an asset's invoked behavior conforms to the committed projected state within a valid acceptance artifact, thereby solving post-portability challenges of semantic mismatch and runtime spoofing.

### CROSS-REFERENCE TO RELATED APPLICATIONS

This application is a continuation-in-part of U.S. Patent Application No. 19/306,300 filed August 21, 2025, entitled “SYSTEM AND METHOD FOR MANAGING AVATARS FOR USE IN MULTIPLE 3D RENDERING PLATFORMS”, which is a continuation of U.S. Patent Application No. 18/323,529, filed on May 25, 2023, titled “SYSTEM AND METHOD FOR MANAGING AVATARS FOR USE IN MULTIPLE 3D RENDERING PLATFORMS,” issued as U.S. Patent No. 12,420,199 on September 23, 2025. The previous applications are incorporated herein by reference in their entirety.

### FIELD OF THE PRESENT DISCLOSURE

The present disclosure relates to portable digital identities and interactive digital content. More particularly, it relates to systems and methods that enable enforceable continuity of a digital identity, character, and associated functional assets across generative world instances using destination-controlled, instance-specific runtime acceptance and conformance enforcement integrated into core engine subsystems.

### BACKGROUND

With the increasing popularity of virtual worlds, games, and metaverses, users often create and customize avatars to represent themselves in these environments. Many video games, metaverses, and other 3D applications exist that allow users to customize their avatars. These applications can be described as online social interactive platforms, where a user's avatar is how they are identified by other users. Often, these applications feature the ability to purchase cosmetic items to further personalize the avatar. Users meticulously configure their avatars in detail, to represent themselves precisely the way they desire other users to see them. These avatars are, in a way, a user's identity in the digital world.

However, current avatar customization solutions are typically limited to a single game or platform, resulting in users having to create and manage multiple avatars across different environments. That is, when a user leaves one application and goes to another, the avatar designed in the previous application is confined to the application in which it was created. The user will need to make another avatar, often with different configuration options, sometimes making it impossible to create a similar avatar. Additionally, any purchased cosmetics are not usable between applications, making them a poor investment. That is, users are unable to transfer their customized avatars or assets, such as clothing or accessories, between different games or platforms. In cases where an application closes down, the avatars and cosmetic purchases are lost forever. Such limitations can be frustrating for users, as they may invest time and resources into customizing their avatars in one environment, only to be unable to use them in another.

Some solutions exist which helps the users to create custom avatars that can be used in various virtual environments. However, these solutions require the users to manually export and import their avatars and associated assets between different environments, which can be cumbersome and time-consuming.

The present disclosure addresses these problems by providing a solution that allows users to maintain a persistent avatar across multiple 3D applications and legitimately own all of their cosmetic purchases. This offers users the ability to have a persistent digital avatar or identity across the digital world.

### SUMMARY

The present disclosure addresses the aforementioned problems by providing a system and method for managing an avatar for a user for use in multiple 3D rendering platforms. The present disclosure enables users to easily customize and modify their avatars using an SDK and API, allowing them to interchange assets for customization of the avatar at runtime across different games, metaverses, and other real-time 3D rendering environments.

In an aspect of the present disclosure, a system for managing an avatar for a user for use in multiple 3D rendering platforms to be executed in a user device is disclosed. Herein, each one of the multiple 3D rendering platforms comprises a 3D game engine module configured to render the avatar in runtime and an in-engine avatar customization module to allow the user to interchange assets for customization of the avatar at the runtime. The system comprises a content database configured to store a 3D model of the avatar and one or more first assets associated with the 3D model of the avatar, as available with the user. The system further comprises a content delivery module communicatively coupled with the content database. The system further comprises a Software Development Kit (SDK) module adaptively integrated with the in-engine avatar customization module of each one of the multiple 3D rendering platforms. The system further comprises an Application Programming Interface (API) module in communication with the content delivery module and the SDK module. Herein, the SDK module is configured to allow for utilization of the 3D model of the avatar and at least one of the one or more first assets compatible with the corresponding in-engine avatar customization module at the runtime, for the user to customize the avatar by implementing the corresponding in-engine avatar customization module. The API module is configured to receive a first request from the SDK module for the 3D model of the avatar and the at least one of the one or more first assets. The content delivery module is configured to fetch the 3D model of the avatar and the at least one of the one or more first assets from the content database in response to the first request at the API module, for delivery to the SDK module. The SDK module is further configured to fetch one or more second assets utilized by the user for customization of the avatar as available in and by implementation of the corresponding in-engine avatar customization module at the runtime. The API module is further configured to receive a second request from the SDK module for the one or more second assets for storage in the content database. The content delivery module is further configured to fetch the one or more second assets from the SDK module in response to the second request at the API module. The content database is configured to store the one or more second assets therein.

In one or more embodiments, the system further comprises a user account module configured to record ownership of the 3D model of the avatar, the one or more first assets and the one or more second assets for the user. In an embodiment, the user account module is configured to implement a distributed ledger for recording the ownership of the 3D model of the avatar, the one or more first assets and the one or more second assets for the user.

In one or more embodiments, the system further comprises a multi-application caching module configured to delete duplicate entries of the 3D model of the avatar, the one or more first assets and the one or more second assets between the multiple 3D rendering platforms in the user device.

In one or more embodiments, the content database and the content delivery module are executed in a server. In an embodiment, the server is a cloud-based server.

In one or more embodiments, the content database and the content delivery module are executed in the user device.

In one or more embodiments, the one or more first assets and the one or more second assets comprise at least one of: separate layers of clothing including shirt, t-shirt, pants, over-jacket; facial features; hair texture; hair color; eyeglasses; make-up features; mask; hat; jewelry; shoes; gloves; music.

In one or more embodiments, the user device comprises at least one of: a personal computer, a smartphone, a gaming console, a portable gaming device, a headset, a heads-up display.

In one or more embodiments, the multiple 3D rendering platforms comprises: video games, metaverses, social virtual reality applications.

In one or more embodiments, the 3D game engine module comprises at least one of: Unity Engine®, Unreal Engine®, Godot Engine®, CryEngine®).

In another aspect of the present disclosure, a method for managing an avatar for a user for use in multiple 3D rendering platforms to be executed in a user device is disclosed. Herein, each one of the multiple 3D rendering platforms comprising a 3D game engine module configured to render the avatar in runtime and an in-engine avatar customization module to allow the user to interchange assets for customization of the avatar at the runtime. The method comprises storing, in a content database, a 3D model of the avatar and one or more first assets associated with the 3D model of the avatar, as available with the user. The method further comprises receiving a command from a user for utilization, via a SDK module integrated with the in-engine avatar customization module of each one of the multiple 3D rendering platforms, of the 3D model of the avatar and at least one of the one or more first assets compatible with the corresponding in-engine avatar customization module at the runtime, to customize the avatar. The method further comprises receiving a first request from the SDK module for the 3D model of the avatar and the at least one of the one or more first assets. The method further comprises fetching the 3D model of the avatar and the at least one of the one or more first assets from the content database in response to the first request, for delivery to the SDK module. The method also comprises fetching one or more second assets utilized by the user for customization of the avatar as available in and by implementation of the corresponding in-engine avatar customization module. The method further comprises receiving a second request from the SDK module for the one or more second assets for storage in the content database. The method further comprises fetching the one or more second assets from the SDK module in response to the second request. The method further comprises storing the one or more second assets in the content database.

In one or more embodiments, the method also comprises recording ownership of the 3D model of the avatar, the one or more first assets and the one or more second assets for the user. In an embodiment, the method comprises implementing a distributed ledger for recording the ownership of the 3D model of the avatar, the one or more first assets and the one or more second assets for the user.

In one or more embodiments, the method also comprises deleting duplicate entries of the 3D model of the avatar, the one or more first assets and the one or more second assets between the multiple 3D rendering platforms in the user device.

In one or more embodiments, the method also comprises executing the content database and the content delivery module in a server.

In one or more embodiments, the method also comprises executing the content database and the content delivery module in the user device.

In an aspect, a computer program is disclosed. The computer program comprises instructions which, when the computer program is executed by a processing unit, cause the processing unit to carry out steps of the aforementioned method.

It is to be appreciated that all the aforementioned implementation forms can be combined. It has to be noted that all devices, elements, circuitry, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

In further embodiments, to address the critical post-portability challenges of semantic mismatch, policy mismatch, and runtime spoofing within generative worlds, the present disclosure provides a destination-controlled acceptance and runtime conformance enforcement framework. This framework is not merely a compatibility check, but a protected control layer for portable digital identities and functional assets.

In one such embodiment, the framework generates a Continuity Capsule. The destination issues a commitment-bearing Destination Acceptance Artifact (DAA) that binds a cryptographic commitment of the asset's projected form to a specific, dynamically instantiated destination context and a freshness field. The framework enforces execution at a plurality of runtime enforcement gates that perform runtime conformance checking, ensuring that an asset’s attempted actions strictly conform to the commitments within the DAA, thereby improving security and correctness in generative environments. The framework enforces execution at a plurality of runtime enforcement gates that perform runtime conformance checking, which goes beyond simple permission validation, ensuring that an asset’s attempted actions strictly conform to the commitments within the DAA. The framework further provides for dynamic re-acceptance cycles to address state-drift in generative environments, ensuring compliance remains intact even when the destination context mutates mid-session. The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present disclosure, reference is now made to the following descriptions taken in connection with the accompanying drawings in which:

FIG. 1 illustrates a diagram of a computing arrangement for implementation of a system for managing an avatar for a user for use in multiple 3D rendering platforms, in accordance with one or more exemplary embodiments of the present disclosure;

FIG. 2 illustrates a diagram of a server, in accordance with one or more exemplary embodiments of the present disclosure;

FIG. 3 illustrates a diagram of a user device, in accordance with one or more exemplary embodiments of the present disclosure;

FIG. 4 illustrates a diagram of a system for managing an avatar for a user for use in multiple 3D rendering platforms, in accordance with one or more exemplary embodiments of the present disclosure;

FIG. 5 illustrates a diagram depicting process flow involved in the system for managing the avatar, in accordance with one or more exemplary embodiments of the present disclosure;

FIG. 6A illustrates an exemplary depiction of a first interface implemented for creating avatar in runtime, in accordance with one or more exemplary embodiments of the present disclosure;

FIG. 6B illustrates an exemplary depiction of a second interface implemented for modelling avatar in runtime, in accordance with one or more exemplary embodiments of the present disclosure;

FIG. 6C illustrates an exemplary depiction of a third interface implemented for customizing avatar in runtime, in accordance with one or more exemplary embodiments of the present disclosure;

FIG. 6D illustrates an exemplary depiction of a fourth interface implemented for finalizing avatar in runtime, in accordance with one or more exemplary embodiments of the present disclosure;

FIG. 7 illustrates a flowchart listing steps involved in a method for managing avatar for a user, in accordance with one or more exemplary embodiments of the present disclosure;

FIG. 8 illustrates an example architecture including a capsule builder, a resolver, a destination acceptance service, and a generative runtime with enforcement gates, in accordance with further embodiments of the disclosure;

FIG. 9 illustrates a Continuity Capsule data structure with identity, character, asset-set, capability, policy, and freshness components;

FIG. 10 illustrates a Destination Capability Profile including action-space verbs, simulation envelopes, compliance constraints, and subsystem declarations;

FIG. 11 illustrates a deterministic projection pipeline for a character and assets into destination-compatible equivalents, including accept, degrade, sandbox, and deny modes;

FIG. 12 illustrates a Destination Acceptance Artifact data structure binding capsule commitments, world instance identifiers, projection commitments, a policy snapshot, and freshness fields;

FIG. 13 illustrates runtime enforcement gates integrated into engine subsystems including spawn/load, animation, physics, input, networking, capture, persistence, and marketplace/UGC;

FIG. 14 illustrates cross-instance continuity between generative world instances using transition intent commitments and chained acceptance artifacts;

FIG. 15 illustrates asset equivalence sets and deterministic fallback ordering for substitutions and degraded variants;

FIG. 16 illustrates zone-based enforcement and multi-mode acceptance, including safe-zone restrictions and selective capability enablement;

FIG. 17 illustrates a Merkle-committed asset-set acceptance and per-asset authorization proofs used at action-gates;

FIG. 18 illustrates offline or intermittently connected acceptance using short-lived freshness seals and revocation windows;

FIG. 19 illustrates multi-origin identity and asset resolution with destination-deterministic selection and integrity verification;

FIG. 20 illustrates a policy compilation process that produces an engine-native enforcement plan enumerating enforcement points and checks;

FIG. 21 illustrates a capture/export control flow wherein acceptance artifacts gate replay encoding, streaming, screenshot modes, and export APIs;

FIG. 22 illustrates a multi-party acceptance embodiment where a destination and an issuer co-sign or countersign acceptance artifacts; and

FIG. 23 illustrates a flowchart for state-drift re-evaluation and dynamic re-acceptance.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In the following description, for purposes of explanation, numerous specific details are set forth in order to provide a thorough understanding of the present disclosure. It will be apparent, however, to one skilled in the art that the present disclosure is not limited to the specific details described herein.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity but rather denote the presence of at least one of the referenced items. Moreover, various features are described which may be exhibited by some embodiments and not by others. Similarly, various requirements are described which may be requirements for some embodiments but not for other embodiments.

Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Unless specified otherwise in the following description, the terms “perform”, “calculate”, “computer-assisted”, “compute”, “establish”, “generate”, “configure”, “reconstruct”, and the like preferably relate to operations and/or processes and/or processing steps that change and/or generate data and/or convert the data into other data, wherein the data may be represented or be present in particular in the form of physical variables, for example in the form of electrical impulses. The expression “computer” should in particular be interpreted as broadly as possible in order in particular to cover all electronic devices having data processing properties. Computers may thus for example be personal computers, servers, programmable logic controllers (PLCs), hand-held computer systems, pocket PC devices, mobile radio devices, and other communication devices able to process data in a computer-assisted manner, processors, and other electronic data processing devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Moreover, a person skilled in the art, with knowledge of the method claim/method claims, is aware of all routine possibilities for realizing products or possibilities for implementation in the prior art, and so there is no need for independent disclosure in the description. These customary realization variants known to the person skilled in the art can be realized exclusively by hardware components or exclusively by software components. Alternatively and/or additionally, the person skilled in the art, within the scope of his/her expert ability, can choose to the greatest possible extent arbitrary combinations according to embodiments of the invention for hardware components and software components in order to implement realization variants according to embodiments of the invention.

Some portions of the detailed description that follows are presented and discussed in terms of a process or method. Although steps and sequencing thereof are disclosed in figures herein describing the operations of this method, such steps and sequencing are exemplary. Embodiments are well suited to performing various other steps or variations of the steps recited in the flowchart of the figure herein, and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. In present implementations, the used language for training may be one of Python, Tensorflow, Bazel, C, C++. Further, decoder in user device (as will be discussed) may use C, C++, or any processor specific ISA. Furthermore, assembly code inside C/C++ may be utilized for specific operation. Also, ASR (automatic speech recognition) and G2P decoder along with entire user system can be run in embedded Linux® (any distribution), Android®, iOS®, Windows®, or the like, without any limitations. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods, and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

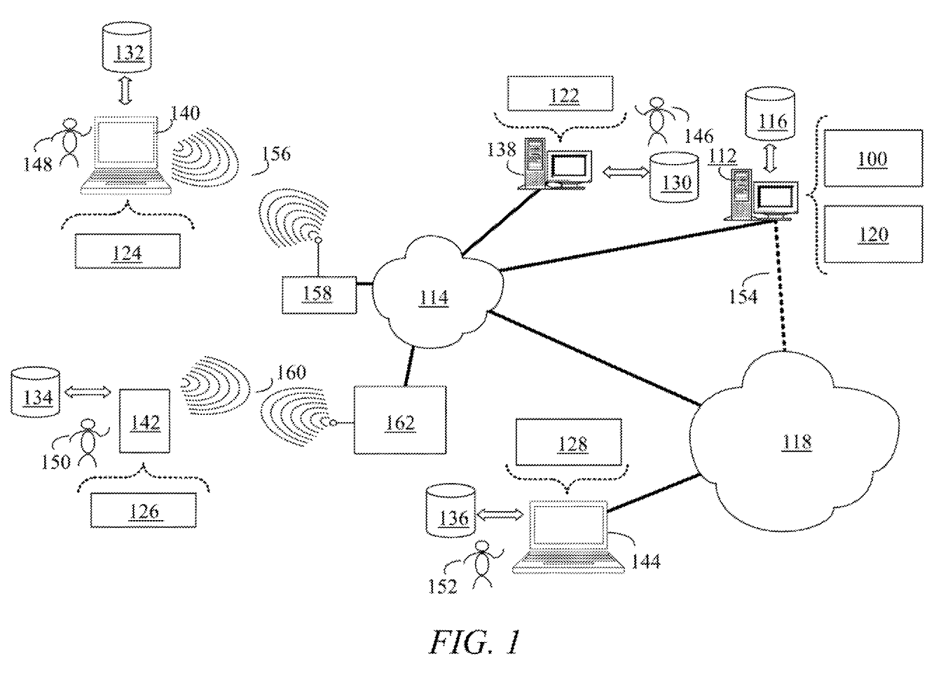

Referring to example implementation of FIG. 1, a computing arrangement 100 may reside on and may be executed by a computer (e.g., computer 112), which may be connected to a network (e.g., network 114) (e.g., the internet or a local area network). Examples of computer 112 may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to Microsoft Windows®; Mac OS X®; Red Hat Linux®, or a custom operating system.

In some implementations, the instruction sets and subroutines of computing arrangement 100, which may be stored on storage devices, such as storage device 116, coupled to computer 112, may be executed by one or more processors (not shown) and one or more memory architectures included within computer 112. In some implementations, storage device 116 may include but is not limited to: a hard disk drive; a flash drive, a tape drive; an optical drive; a RAID array (or other array); a random-access memory (RAM); and a read-only memory (ROM).

In some implementations, network 114 may be connected to one or more secondary networks (e.g., network 118), examples of which may include but are not limited to: a local area network; a wide area network; or an intranet, for example.

In some implementations, computer 112 may include a data store, such as a database (e.g., relational database, object-oriented database, triplestore database, etc.) and may be located within any suitable memory location, such as storage device 116 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, computing arrangement 100 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute application 120 for managing an avatar for a user for use in multiple 3D rendering platforms. In some implementations, computing arrangement 100 and/or application 120 may be accessed via one or more of client applications 122, 124, 126, 128. In some implementations, computing arrangement 100 may be a standalone application, or may be an applet/application/script/extension that may interact with and/or be executed within application 120, a component of application 120, and/or one or more of client applications 122, 124, 126, 128. In some implementations, application 120 may be a standalone application, or may be an applet/application/script/extension that may interact with and/or be executed within computing arrangement 100, a component of computing arrangement 100, and/or one or more of client applications 122, 124, 126, 128. In some implementations, one or more of client applications 122, 124, 126, 128 may be a standalone application, or may be an applet/application/script/extension that may interact with and/or be executed within and/or be a component of computing arrangement 100 and/or application 120. Examples of client applications 122, 124, 126, 128 may include, but are not limited to, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to user devices 138, 140, 142, 144, may be executed by one or more processors and one or more memory architectures incorporated into user devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of user devices 138, 140, 142, 144 (and/or computer 112) may include, but are not limited to, a personal computer (e.g., user device 138), a laptop computer (e.g., user device 140), a smart/data-enabled, cellular phone (e.g., user device 142), a notebook computer (e.g., user device 144), a tablet (not shown), a server (not shown), a television (not shown), a smart television (not shown), a media (e.g., video, photo, etc.) capturing device (not shown), and a dedicated network device (not shown). User devices 138, 140, 142, 144 may each execute an operating system, examples of which may include but are not limited to Android, Apple IOS, Mac OS X; Red Hat Linux, or a custom operating system.

In some implementations, one or more of client applications 122, 124, 126, 128 may be configured to effectuate some or all of the functionality of computing arrangement 100 (and vice versa). Accordingly, in some implementations, computing arrangement 100 may be a purely server-side application, a purely client-side application, or a hybrid server-side/client-side application that is cooperatively executed by one or more of client applications 122, 124, 126, 128 and/or computing arrangement 100.

In some implementations, one or more of client applications 122, 124, 126, 128 may be configured to effectuate some or all of the functionality of application 120 (and vice versa). Accordingly, in some implementations, application 120 may be a purely server-side application, a purely client-side application, or a hybrid server-side/client-side application that is cooperatively executed by one or more of client applications 122, 124, 126, 128 and/or application 120. As one or more of client applications 122, 124, 126, 128, computing arrangement 100, and application 120, taken singly or in any combination, may effectuate some or all of the same functionality, any description of effectuating such functionality via one or more of client applications 122, 124, 126, 128, computing arrangement 100, application 120, or combination thereof, and any described interaction(s) between one or more of client applications 122, 124, 126, 128, computing arrangement 100, application 120, or combination thereof to effectuate such functionality, should be taken as an example only and not to limit the scope of the disclosure.

In some implementations, one or more of users 146, 148, 150, 152 may access computer 112 and computing arrangement 100 (e.g., using one or more of user devices 138, 140, 142, 144) directly through network 114 or through secondary network 118. Further, computer 112 may be connected to network 114 through secondary network 118, as illustrated with phantom link line 154. Computing arrangement 100 may include one or more user interfaces, such as browsers and textual or graphical user interfaces, through which users 146, 148, 150, 152 may access computing arrangement 100.

In some implementations, the various user devices may be directly or indirectly coupled to communication network, such as communication network 114 and communication network 118, hereinafter simply referred to as network 114 and network 118, respectively. For example, user device 138 is shown directly coupled to network 114 via a hardwired network connection. Further, user device 144 is shown directly coupled to network 118 via a hardwired network connection. User device 140 is shown wirelessly coupled to network 114 via wireless communication channel 156 established between user device 140 and wireless access point (i.e., WAP) 158, which is shown directly coupled to network 114. WAP 158 may be, for example, an IEEE 802.11a, 802.11b, 802.11g, Wi-Fi, RFID, and/or Bluetooth (including Bluetooth Low Energy) device that is capable of establishing wireless communication channel 156 between user device 140 and WAP 158. User device 142 is shown wirelessly coupled to network 114 via wireless communication channel 160 established between user device 142 and cellular network/bridge 162, which is shown directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example, Bluetooth (including Bluetooth Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

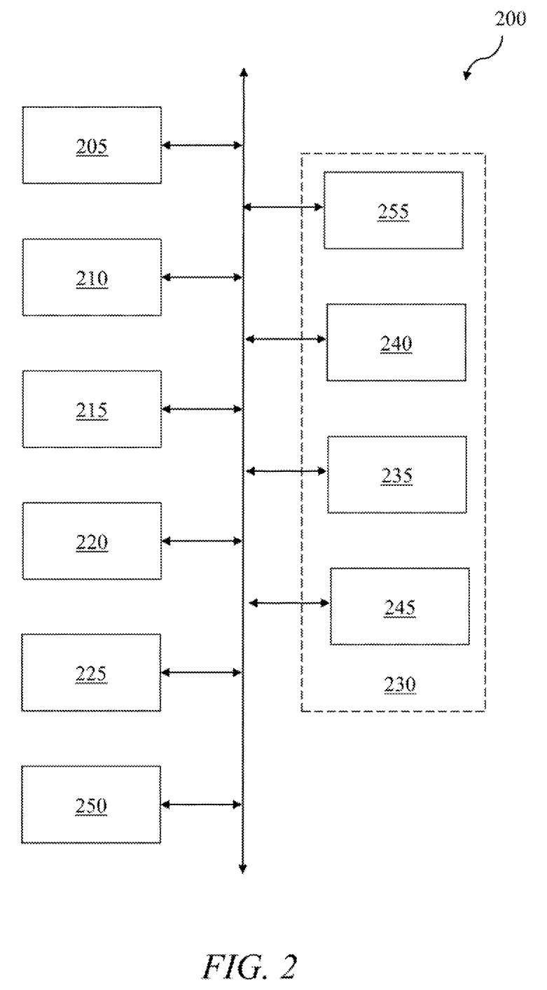

The computing arrangement 100 may include a server (such as server 200, as shown in FIG. 2) for managing an avatar for a user for use in multiple 3D rendering platforms. In the present implementations, the computing arrangement 100 itself may be embodied as the server 200. Herein, FIG. 2 is a block diagram of an example of the server 200 capable of implementing embodiments according to the present disclosure. In the example of FIG. 2, the server 200 may include a processing unit 205 for running software applications (such as, the application 120 of FIG. 1) and optionally an operating system. As illustrated, the server 200 may further include a database 210 which stores applications and data for use by the processing unit 205. Storage 215 provides non-volatile storage for applications and data and may include fixed disk drives, removable disk drives, flash memory devices, CD-ROM, DVD-ROM, or other optical storage devices. An optional user input device 220 may include devices that communicate user inputs from one or more users to the server 200 and may include keyboards, mice, joysticks, touch screens, etc. A communication or network interface 225 is provided which allows the server 200 to communicate with other computer systems via an electronic communications network, including wired and/or wireless communication and including an Intranet or the Internet. In one embodiment, the server 200 receives instructions and user inputs from a remote computer through communication interface 225. Communication interface 225 can comprise a transmitter and receiver for communicating with remote devices. An optional display device 250 may be provided which can be any device capable of displaying visual information in response to a signal from the server 200. The components of the server 200, including the processing unit 205, the database 210, the data storage 215, the user input devices 220, the communication interface 225, and the display device 250, may be coupled via one or more data buses, such as data bus 260.

In the embodiment of FIG. 2, a graphics system 230 may be coupled with the data bus 260 and the components of the server 200. The graphics system 230 may include a physical graphics processing arrangement (GPU) 235 and graphics memory. The GPU 235 generates pixel data for output images from rendering commands. The physical GPU 235 can be configured as multiple virtual GPUs that may be used in parallel (concurrently) by a number of applications or processes executing in parallel. For example, mass scaling processes for rigid bodies or a variety of constraint solving processes may be run in parallel on the multiple virtual GPUs. Graphics memory may include a display memory 240 (e.g., a framebuffer) used for storing pixel data for each pixel of an output image. In another embodiment, the display memory 240 and/or additional memory 245 may be part of the database 210 and may be shared with the processing unit 205. Alternatively, the display memory 240 and/or additional memory 245 can be one or more separate memories provided for the exclusive use of the graphics system 230. In another embodiment, the graphics system 230 may include one or more additional physical GPUs 255, similar to the GPU 235. Each additional GPU 255 may be adapted to operate in parallel with the GPU 235. Each additional GPU 255 generates pixel data for output images from rendering commands. Each additional physical GPU 255 can be configured as multiple virtual GPUs that may be used in parallel (concurrently) by a number of applications or processes executing in parallel, e.g., processes that solve constraints. Each additional GPU 255 can operate in conjunction with the GPU 235, for example, to simultaneously generate pixel data for different portions of an output image, or to simultaneously generate pixel data for different output images. Each additional GPU 255 can be located on the same circuit board as the GPU 235, sharing a connection with the GPU 235 to the data bus 260, or each additional GPU 255 can be located on another circuit board separately coupled with the data bus 260. Each additional GPU 255 can also be integrated into the same module or chip package as the GPU 235. Each additional GPU 255 can have additional memory, similar to the display memory 240 and additional memory 245 or can share the memories 240 and 245 with the GPU 235. It is to be understood that the circuits and/or functionality of GPU as described herein could also be implemented in other types of processors, such as general-purpose or other special-purpose coprocessors, or within a CPU.

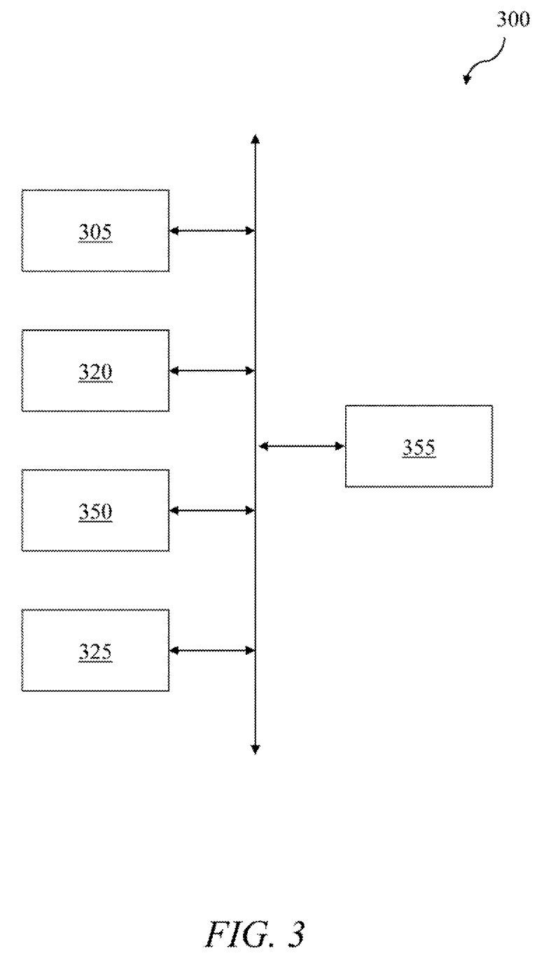

The computing arrangement 100 may also include a user device 300 (as shown in FIG. 3). In embodiments of the present disclosure, the user device 300 may embody a smartphone, a personal computer, a tablet, or the like. Herein, FIG. 3 is a block diagram of an example of the user device 300 capable of implementing embodiments according to the present disclosure. In the example of FIG. 3, the user device 300 may include a processor 305 (hereinafter, referred to as a CPU) for running software applications (such as, the application 120 of FIG. 1) and optionally an operating system. A user input device 320 is provided which may include devices that communicates user inputs from one or more users and may include keyboards, mice, joysticks, touch screens, and/or microphones. Further, a network adapter 325 is provided which allows the user device 300 to communicate with other computer systems (e.g., the server 200 of FIG. 2) via an electronic communications network, including wired and/or wireless communication and including the Internet. The user device 300 may also include a decoder 355 may be any device capable of decoding (decompressing) data that may be encoded (compressed). A display device 350 may be provided which may be any device capable of displaying visual information, including information received from the decoder 355. In particular, as will be described below, the display device 350 may provide an interface, such that the display device 350 is configured to display information received from the server 200 of FIG. 2. The components of the user device 300 may be coupled via one or more data buses 360.

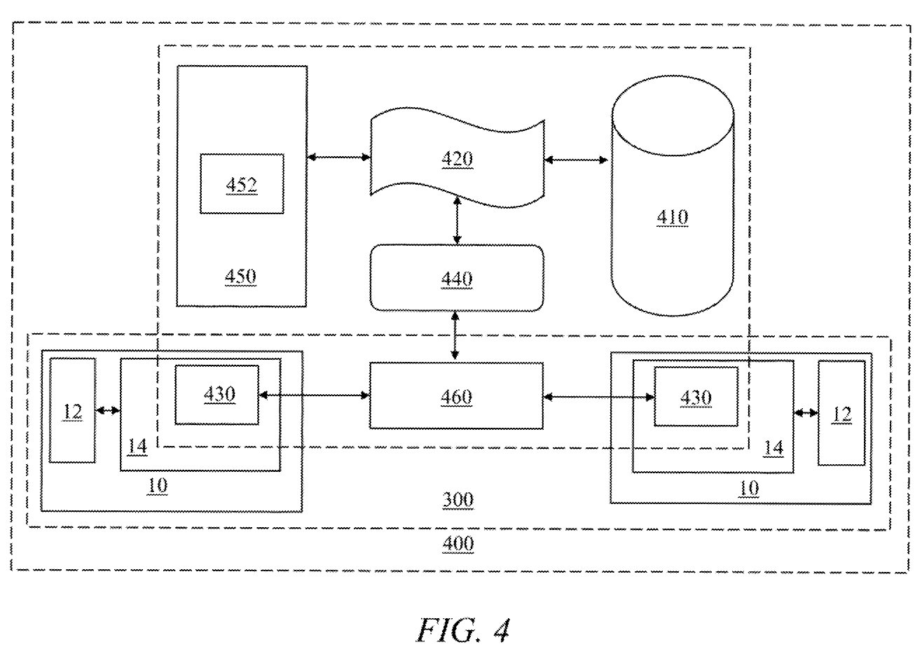

Referring to FIG. 4, illustrated is an exemplary block diagram of a system 400 for managing an avatar for a user for use in multiple 3D rendering platforms (as represented by reference numeral 10). The system 400, as described in the present disclosure, is integrated within the computing arrangement 100, and may be specifically implemented in the user device 300 in combination with (or without) the server 200 of the computing arrangement 100. Herein, the server 200 may manage and coordinate the necessary data, processing, and communication involved in the proper functioning of the system 400. Simultaneously, the user device 300 may serve as an interactive interface for users to engage with the system 400, offering customization options, access to assets, and seamless interaction with the multiple real-time 3D rendering platforms. By implementing the system 400 within the server 200 and the user device 300, the present invention ensures a comprehensive and coherent framework for creating and customizing avatars, as well as providing a consistent user experience across various games, metaverses, or any other real-time 3D rendered environments.

In context of the present disclosure, the 3D rendering platforms 10 refer to various interactive digital environments that utilize real-time 3D graphics to display and navigate within their respective virtual worlds. The 3D rendering platforms 10 cater to different audiences and purposes, creating diverse experiences that rely on 3D graphics technology for realistic and engaging interactions. In present examples, the 3D rendering platforms 10 may be real-time rendering platforms, in which the real-time aspect signifies that the graphical content is continuously rendered and updated based on user interactions, ensuring a responsive and dynamic experience. Real-time 3D graphics technology enables the rendering of 3D scenes, objects, and characters with rapid updates based on user inputs or changing conditions within the virtual environment. Such technology relies on sophisticated algorithms and hardware acceleration to achieve smooth and fluid visuals, allowing users to experience an immersive, dynamic, and interactive environment.

Specifically, in embodiments of the present disclosure, the 3D rendering platforms 10 include those platforms that provide an avatar for the user, allowing the users to represent themselves within the virtual environment. As used herein, an avatar is a customizable digital representation of the user within the virtual environment. The avatar may take various forms, ranging from human-like characters to fantastical creatures or abstract entities, depending on the specific platform and user preferences. The avatar serves as the user's digital identity, allowing them to interact with other users and the virtual environment. The objective of the present disclosure is to enable users to maintain a consistent and persistent avatar across these diverse platforms, enhancing their experience and digital identity. The system 400 of the present disclosure aims to manage the avatars for the user, so that these avatars may be used across various 3D rendering platforms 10, allowing users to maintain a consistent and persistent digital identity throughout their online experiences.

For purposes of the present disclosure, the multiple 3D rendering platforms 10 encompass a wide range of interactive digital environments, including video games, metaverses, and social virtual reality applications. Video games are interactive entertainment experiences that involve real-time 3D graphics to create immersive environments for players to navigate and engage with. They can span various genres, such as role-playing games (RPGs), first-person shooters (FPS), and massively multiplayer online games (MMOs). Metaverses are expansive, interconnected virtual worlds that allow users to explore, socialize, and participate in various activities. These digital spaces provide a platform for users to create and customize their own avatars, build virtual environments, and interact with other users in real-time. Metaverses can be used for a wide range of purposes, including entertainment, education, social networking, c-commerce, and collaborative workspaces. Social virtual reality applications are platforms that utilize virtual reality (VR) technology to create immersive social experiences for users. These applications enable users to interact with others in a shared virtual environment, using avatars as their digital representations. In each of these 3D rendering platforms, avatars play a critical role in representing users and enabling them to interact within the virtual environment.

As may be contemplated, each one of the multiple 3D rendering platforms 10 may include a 3D game engine module (as represented by reference numeral 12) configured to render the avatar in runtime. The 3D game engine module 12 is a software framework designed for the development and execution of interactive 3D applications, such as video games, simulations, and virtual environments. The 3D game engine module 12 provides a range of tools and functionalities, including rendering, physics, animation, and artificial intelligence, which enable developers to create immersive and interactive experiences. Rendering is the process of converting the digital representation of an avatar, including its geometry, textures, and animations, into a visually coherent form that can be displayed on the user's device. As used herein, runtime refers to the period during which a 3D application or game is actively executing and being interacted with by the user. In contrast to the development phase, where assets and functionalities are being created and integrated, runtime encompasses the actual experience of the user as they navigate and interact within the 3D environment.

Herein, the 3D game engine module 12 may include at least one of the following popular and widely used game engines, such as Unity Engine®, Unreal Engine®, Godot Engine® CryEngine®. Each of these game engines offers unique capabilities and advantages, and the present disclosure may be implemented using any one or a combination of these engines to create a seamless and persistent avatar experience across the multiple 3D rendering platforms 10. By leveraging the capabilities of the 3D game engine module 12, the avatar can be rendered in real-time, allowing for smooth and responsive interaction with the virtual environment and other users. In addition to rendering the avatar, the 3D game engine module 12 may also manage other aspects of the avatar's behavior and appearance during runtime, such as handling animation, collision detection, and physics interactions. This ensures that the user's avatar behaves and reacts realistically within the context of the 3D rendering platform 10, providing a seamless and immersive experience.

Further, each one of the multiple 3D rendering platforms 10 may include an in-engine avatar customization module (as represented by reference numeral 14) to allow the user to interchange assets for customization of the avatar at the runtime. That is, the in-engine avatar customization module 14 enables the users to seamlessly interchange and modify assets of their avatar in real-time while they are using the 3D rendering platforms 10. The in-engine avatar customization module 14 allows for a more dynamic and personalized experience by providing users with the ability to make adjustments to their avatars without having to leave the platform or restart the application. By offering these customization options and more within the 3D rendering platforms 10, the in-engine avatar customization module 14 significantly enhances the user experience, promoting a deeper sense of identity and personalization within the digital world.

As used herein, the assets refer to a wide range of customizable elements or components that users can apply to their avatars in order to personalize and enhance their digital personas. These assets help in creating a unique and distinctive appearance for each user's avatar, contributing to a more immersive and engaging experience across the 3D rendering platforms 10. The assets may encompass a diverse array of customizable elements, including separate layers of clothing including shirt, t-shirt, pants, over-jacket; facial features; hair texture; hair color; eyeglasses; make-up features; mask; hat; jewelry; shoes; gloves; music. The separate layers of clothing such as shirts, t-shirts, pants, and over-jackets allow users to mix and match different styles and outfits and can be layered on top of each other. Additionally, users can modify facial features to create a desired expression or resemblance, while hair texture and color options provide further customization possibilities. Accessories such as eye-glasses, make-up features, masks, hats, and jewelry can be added or removed to give the avatar a unique look. Further, users can choose from a variety of shoes and gloves to complete their avatars' outfits. Furthermore, music can serve as an audio asset that adds a personal touch to the user's digital persona. Users can select a specific track, melody, or sound effect to accompany their avatar, creating a unique auditory signature that reflects their taste and style. By providing a comprehensive selection of assets, the present invention enables users to tailor their digital identities to their personal preferences, fostering a greater sense of individuality and self-expression within the virtual worlds of 3D rendering platforms.

As discussed, the in-engine avatar customization module 14 offers users the ability to effortlessly interchange and modify their avatars' assets in real-time as they engage with the 3D rendering platforms 10. Swapping outfits is one example, as users within a metaverse or virtual social space may wish to alter their avatars' clothing to suit a specific theme or event. The in-engine avatar customization module 14 facilitates easy transitions between various outfits or clothing pieces, rendering avatars readily adaptable to diverse situations. Additionally, the in-engine avatar customization module 14 permits users to adjust facial features to convey a particular emotion or more accurately reflect their real-life appearance, thereby enhancing the authenticity and personal connection with their digital personas. Accessory customization is another feature of the in-engine avatar customization module 14, enabling users to add or remove items such as hats, glasses, or jewelry for an added layer of personalization. Users can conveniently experiment with a range of accessory combinations to achieve their desired look or style. Changing hairstyles is also made possible through the in-engine avatar customization module 14, allowing users to modify their avatars' hairstyles to suit their preferences or to align with a specific event or theme, all without leaving the 3D rendering platform 10. Lastly, the in-engine avatar customization module 14 may incorporate in-game items, wearables, or assets acquired within a specific game or platform into the user's avatar. This functionality enables users to display their in-game achievements or purchases across multiple 3D rendering platforms 10.

In present examples, the 3D rendering platforms 10 may be executed in a user device (such as, the user device 300). That is, these 3D rendering platforms 10 can be accessed by users through their user devices 300, which encompass a wide range of hardware and form factors to provide versatile and convenient access to the virtual worlds. For purposes of the present disclosure, the user device 300 may include various types of hardware that allow users to access and interact with the 3D rendering platforms 10. In present embodiments, the user device 300 may include at least one of: a personal computer, a smartphone, a gaming console, a portable gaming device, a headset, and a heads-up display. Herein, a personal computer, for example, can be a desktop or laptop computer that enables users to run gaming applications, virtual worlds, or metaverse platforms, providing a wide range of customization and interaction options through peripherals such as a keyboard, mouse, or gaming controllers. A smartphone, on the other hand, offers a portable and convenient way for users to access these platforms through mobile applications, utilizing touch-based controls and built-in sensors for interaction. Gaming consoles, such as PlayStation®, Xbox®, or Nintendo Switch®, provide a dedicated platform for gaming experiences, including online multiplayer games and social virtual worlds, often with specialized controllers for intuitive input. Portable gaming devices, like the Nintendo Switch Lite or PlayStation Vita, combine the convenience of a mobile device with dedicated gaming hardware, allowing users to engage with their avatars on-the-go. Headsets, such as VR or augmented reality (AR) devices, immerse users in the virtual environment, providing an even more immersive and intuitive experience through natural movements and gestures. Finally, heads-up displays, like Google Glass or other smart glasses, overlay digital information onto the user's view of the real world, enabling seamless integration between the virtual and physical realms. Each of these user devices 300 allows users to interact with their avatars across the said multiple 3D rendering platforms 10.

According to an embodiment, as illustrated in FIG. 4, the system 400 of the present disclosure includes a content database 410 configured to store a 3D model of the avatar and one or more assets associated with the 3D model of the avatar, as available with the user; a content delivery module 420 communicatively coupled with the content database 410, and configured to fetch the avatar and the assets from the content database 410 and deliver data; a SDK module 430 adapted to be integrated with the in-engine avatar customization module 14 of each one of the multiple 3D rendering platforms 10, and configured to allow for utilization of the said 3D model of the avatar and at least one of the said one or more assets compatible with the corresponding in-engine avatar customization module at the runtime, for the user to customize the avatar by implementing the said corresponding in-engine avatar customization module; and an API module 440 in communication with the content delivery module 420 and the SDK module 430, and configured to process requests from the SDK module 430 for avatar and asset data from the content database 410 via the content delivery module 420.

In particular, the content database 410 is designed to store and manage the 3D models of avatars along with one or more assets associated with each respective 3D model of the avatar. The content database 410 ensures that the user's avatar and associated assets are readily available for use across various real-time 3D rendering platforms 10. By housing the 3D models of user avatars and their associated assets in a centralized location, the content database 410 enables efficient data management and retrieval, facilitating seamless access and interaction with the avatars across multiple 3D rendering platforms 10. The content database 410 may also ensure that user avatars and associated assets are compatible with different real-time 3D rendering platforms 10. Metadata associated with each avatar and asset may also be stored in the content database 410. This metadata may include, but is not limited to, asset type, asset category, asset creator information, and asset ownership information.

In some examples, the content database 410 may also support versioning for avatars and assets, enabling users to maintain multiple versions of their avatar or individual assets. This feature allows users to revert to a previous version of their avatar or asset if desired, providing an additional level of customization and control. In some examples, the content database 410 may be configured with appropriate access control mechanisms, ensuring that users can access and modify their own avatars and associated assets without being able to access others’ avatars and associated assets. These access controls may include authentication, authorization, and encryption techniques to protect user data and maintain privacy. The content database 410 may also be structured in a hierarchical manner, with each user's avatar and its associated assets grouped together. The content database 410 may utilize a scalable and efficient storage system that can accommodate the growing number of avatars and associated assets. Such storage system may employ a combination of relational databases, NoSQL databases, and/or distributed file systems to ensure the optimal organization and retrieval of data. To further enhance the performance of the content database, various optimization techniques may be employed, such as caching, indexing, and load balancing. These techniques help ensure that the content database can efficiently serve avatars and assets to users across multiple real-time 3D rendering platforms, even under high-traffic conditions.

The SDK module 430 enables the integration and seamless interoperability of the in-engine avatar customization module 14 across the multiple 3D rendering platforms 10. The SDK module 430 provides developers with the necessary tools, libraries, and guidelines to implement the system's functionalities within the respective 3D rendering platforms 10. Specifically, the SDK module 430 facilitates the utilization of the 3D model of the avatar and at least one of the assets stored in the content database 410, ensuring compatibility with the corresponding in-engine avatar customization module 14. By integrating the SDK module 430 into the 3D rendering platforms 10, developers can enable users to customize their avatars using the available assets (and any additional second assets, as discussed later in the description) in real-time, during runtime of the corresponding 3D rendering platform 10. Thus, the SDK module 430 serves as a link in the system 400, bridging the gap between the content database 410, and the in-engine avatar customization module 14 and the multiple 3D rendering platforms 10.

It may be understood that the SDK module 430 takes into consideration the unique requirements and specifications of the corresponding in-engine avatar customization module 14 when allowing for the utilization of the 3D model of the avatar and at least one of the assets. This involves converting or adapting the 3D model and assets into a format that can be readily understood and processed by the in-engine avatar customization module. The SDK module 430 may also account for any differences in the way assets are handled, rendered, or animated across different 3D rendering platforms 10, ensuring that the avatar and associated assets maintain their intended appearance and functionality regardless of the 3D rendering platform 10. It may also be appreciated that in addition to providing compatibility between with the multiple 3D rendering platforms 10, the SDK module 430 may also help maintain a consistent user experience. The SDK module 430 ensures that the avatar customization features are accessible and function similarly across different 3D rendering platforms 10, thereby allowing the users to modify their avatars quickly and easily without encountering platform-specific limitations or discrepancies. Furthermore, the SDK module enables the developers to add or update avatar assets, customization options, and other features as needed, ensuring that the system 400 remains adaptable and up to date with evolving user preferences and industry trends.

The API module 440 facilitates seamless communication between various components, such as the content delivery module 420, the SDK module 430, and other integrated services in the system 400. By providing a standardized set of protocols, conventions, and functions, the API module 440 ensures that different parts of the system 400 can efficiently exchange information and work together harmoniously. Specifically, herein, the API module 440 is configured to receive a request from the SDK module 430 for specific resources, such as the 3D model of the avatar and the associated assets. Upon receiving the request, the API module 440 processes the request and communicates with the content delivery module 420 to retrieve the requested data. After acquiring the necessary information, the API module 440 sends the data back to the SDK module 430, which in turn utilizes the data to customize and render the avatar within the corresponding 3D rendering platform 10. It may be appreciated that, additionally, the API module 440 may also serve as an abstraction layer in the system 400, shielding the internal workings of the system 400 and providing a simplified interface for developers to work with. This allows developers to focus on building and customizing their avatars and assets without needing to delve into the intricacies of underlying architecture the system 400.

The content delivery module 420 is responsible for the efficient retrieval and delivery of the 3D model of the avatar and the associated assets from the content database 410 to the SDK module 430. The content delivery module 420 facilitates seamless communication between the content database 410 and the SDK module 430, ensuring that the necessary avatar and asset data are readily available for customization and rendering within the various 3D rendering platforms. Specifically, the content delivery module 420 processes the incoming request from the API module 440, queries the content database 410, and retrieves the relevant data. The integration of the content delivery module 420 within the present system 400 helps to maintain a seamless and efficient workflow between the content database 410, the API module 440, and the SDK module 430. By working in tandem with these other components, the content delivery module 420 allows users to access and customize their avatars and assets with minimal delays, regardless of their specific 3D rendering platform 10 or the user device 300.

In addition to its primary function of fetching and delivering the 3D model of the avatar and the assets, the content delivery module 420 may also serve a broader role in optimizing the performance and user experience within the system 400. The content delivery module 420 may employ various caching mechanisms and strategies to minimize latency, reduce bandwidth consumption, and ensure the timely delivery of content. For instance, to improve performance and reduce response times, the content delivery module 420 may incorporate a caching mechanism which stores frequently requested avatar models and assets in a cache, thereby minimizing the need for repetitive database queries and speeding up content delivery. To handle varying levels of demand and ensure optimal performance, the content delivery module 420 may include a load balancing component, which distributes incoming requests across multiple instances of the content delivery module 420, ensuring that no single instance becomes overwhelmed with traffic. To protect the integrity of the content and prevent unauthorized access, the content delivery module 420 may also incorporate security and authentication mechanisms, which validate incoming requests, verify user credentials, and apply encryption to the content, as necessary.

The content delivery module 420 may also leverage advanced algorithms and techniques to prioritize and manage the delivery of assets based on factors such as network conditions, user location, and device capabilities. This ensures that the user experience remains consistent and responsive, even in situations where network connectivity or device performance may be less than optimal. In an embodiment, the content delivery module 420 utilizes a Content Delivery Network (CDN) to further optimize the retrieval and distribution of the 3D model of the avatar and the associated assets to user devices 300 across various 3D rendering platforms 10. A CDN is a globally distributed network of servers that work together to provide fast and efficient delivery of content to users based on their geographical location and proximity to the CDN servers. By leveraging the geographical distribution of CDN servers, the content delivery module 420 can deliver the 3D model of the avatar and the assets from a server that is closer to the user's location, resulting in reduced latency and faster response times. The CDN may further improve reliability by distributing content across multiple servers and locations, ensuring that the 3D model of the avatar and the assets remain available and accessible even in the event of server outages or network disruptions. Further, as the number of users and the demand for content increases, the CDN can easily scale to accommodate the growing traffic without compromising the performance of the content delivery module 420, and thereby the overall system 400.

In operation of the present system 400, when the user initiates a customization request, the SDK module 430 communicates with the API module 440, sending a first request for the 3D model of the avatar and first assets. Herein, the term “first assets” refers to the initial set of digital items, features, or components associated with a user's avatar within the content database 410. That is, the first assets are the pre-existing assets available to a user when they first create or customize their avatar within a specific 3D rendering platform 10. These first assets are directly linked to the 3D model of the avatar and may include various customization options such as clothing, facial features, hair textures and colors, accessories, and more. Further, the term “first request” refers to the initial communication initiated by the SDK module 430 to the API module 440 when the user wishes to access and utilize these first assets for avatar customization. Upon receiving the first request from the SDK module 430, the API module 440 forwards the first request to the content delivery module 420. The content delivery module 420 is responsible for fetching the requested 3D model of the avatar and the first assets from the content database 410. The content delivery module 420 efficiently retrieves the requested content, leveraging caching mechanisms and the CDN, if required, to ensure optimal performance and quick response times. Once the content delivery module 420 has fetched the 3D model of the avatar and the relevant first assets from the content database 410, the content delivery module 420 delivers this data back to the SDK module 430. The SDK module 430 then integrates the fetched content with the in-engine avatar customization module 14, enabling the user to seamlessly customize their avatar in real-time within the 3D rendering platform 10. This streamlined process ensures that users can effortlessly personalize their avatars across multiple 3D rendering platforms 10, fostering a more engaging and immersive experience for users as they interact within various virtual environments.

In some scenarios, the user may acquire new customization assets, referred to as “second assets,” while using the 3D rendering platforms 10. These second assets may include additional clothing, accessories, or other personalization elements that the user obtains through in-platform achievements, purchases, or other means. To ensure that these newly acquired assets are accessible for future avatar customization, the system 400 allows to save these second assets in the content database 410. For this purpose, the SDK module 430 is further configured to fetch one or more second assets utilized by the user for customization of the avatar as available in and by implementation of the said corresponding in-engine avatar customization module 14 at the runtime. That is, the SDK module 430, integrated with the in-engine avatar customization module 14 of the 3D rendering platform 10, detects the user's utilization of the newly acquired second assets at runtime. The SDK module 430 then retrieves these second assets from the in-engine avatar customization module 14. Also, the API module 440 is further configured to receive a second request from the SDK module 430 for the said one or more second assets for storage in the content database 410. That is, once the second assets are fetched, the SDK module 430 sends a second request to the API module 440. This second request may contain the acquired second assets and may indicate that they should be stored in the content database 410. Further, the content delivery module 420 is further configured to fetch the said one or more second assets from the SDK module 430 in response to the said second request at the API module 440. That is, in response to the second request received at the API module 440, the content delivery module 420 retrieves the second assets from the SDK module 430. This ensures that the content delivery module 420 has access to the new assets for subsequent storage and distribution. Furthermore, the content database 410 is configured to store the said one or more second assets therein. That is, after retrieving the second assets from the SDK module 430, the content delivery module 420 stores them in the content database 410. This allows users to access and utilize the new assets for future avatar customization across the multiple 3D rendering platforms 10. By implementing this process, the system 400 ensures that users' newly acquired assets (i.e., second assets) are saved to be readily available for use in future avatar customization sessions.

According to one or more embodiments, as illustrated in FIG. 4, the system 400 may further include a user account module 450 for recording ownership of the avatar and associated assets for the user. Herein, the user account module 450 records the ownership of the user's 3D avatar model, the initial first assets, and any additional second assets. This ensures that the system 400 accurately tracks digital belongings of the user and enables a smooth and secure user experience across the multiple 3D rendering platforms 10. For this purpose, when a user may first register in the system 400, the user account module 450 creates a unique account for such user, which stores the user's avatar, first assets, and any subsequently acquired second assets. The user account module 450, in conjunction with other components of the system 400 such as the content database 410, ensures that user has access to their avatars and associated assets across the multiple 3D rendering platforms 10. This feature enables a consistent and personalized user experience, regardless of the 3D rendering platform 10 being used.

In an embodiment, the user account module 450 is configured to implement a distributed ledger 452 for recording the ownership of the 3D model of the avatar, the one or more first assets and the one or more second assets for the user. That is, the user account module 450 may implement the distributed ledger 452, such as a blockchain, to provide a secure and transparent method of tracking asset ownership. It may be contemplated by a person skilled in the art that these records may be stored in the distributed ledger 452 to provide a clear and immutable history of each user's digital belongings. This technology ensures that the ownership records are tamper-resistant and easily verifiable, enhancing trust in the system 400. The distributed ledger 452 implemented by the user account module 450 further enables secure and transparent asset transfers between users, such as trading or gifting avatar customization items. Thereby, the user account module 450 is able to track these transactions and updates the ownership records accordingly.

Also, as illustrated in FIG. 4, the system 400 may further include a multi-application caching module 460 for deleting duplicate entries of the 3D model of the avatar and associated assets between the multiple 3D rendering platforms 10 in the user device 300. That is, the system 400 may also incorporate the multi-application caching module 460 designed to optimize the storage and management of the 3D avatar model and its associated assets in the user device 300 when accessed across multiple 3D rendering platforms 10. For this purpose, the multi-application caching module 460 may continuously monitor the cache storage on the user device 300, identifying instances where the 3D avatar model and associated assets are being duplicated across different 3D rendering platforms 10. Upon detecting duplicate entries, the multi-application caching module 460 consolidates them into a single, unified cache entry. This process ensures that one instance of the 3D avatar model and its related assets are stored on the user device 300, regardless of the number of the 3D rendering platforms 10 being used. Further, the multi-application caching module 460 synchronizes the unified cache entry with each 3D rendering platform 10 to maintain consistency across the 3D rendering platforms 10 and thus ensures that any changes or updates made to the avatar or assets in one of the 3D rendering platforms 10 are reflected across all other platforms, providing a seamless user experience. Finally, the multi-application caching module 460 also efficiently manages the cache storage by regularly checking for outdated or unused avatar models and assets and removing them, as necessary. By eliminating duplicate entries, the multi-application caching module 460 conserves storage space and enhances the overall performance of the user device 300.

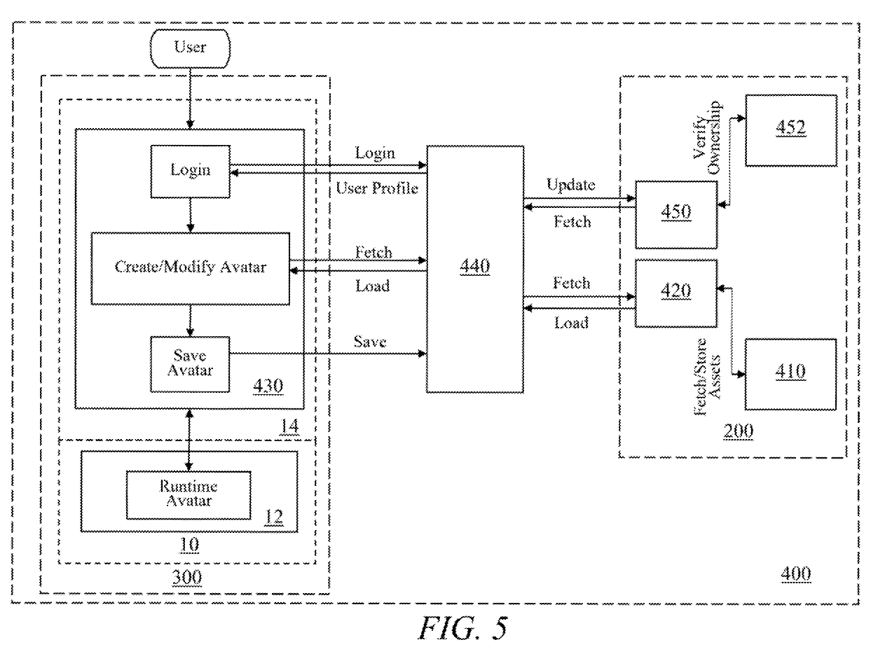

Referring to FIG. 5, illustrated is a schematic diagram depicting process flow for implementation of the present system 400 for managing the avatar for the user for use in the multiple 3D rendering platforms 10. The user initiates the process by logging in to the SDK module 430, which is integrated into the in-engine avatar customization module 14 of each 3D rendering platform 10. The login request is sent to the user account module 450 via the API module 440. The user account module 450 verifies the user's credentials and grants them access to their avatar and associated assets, via the API module 440. The user account module 450 incorporates the distributed ledger 452 to record and manage the ownership of the avatar and associated assets. Upon successful login, the user is presented with options to create a new avatar or modify an existing one using the in-engine avatar customization module 14. The user may customize their avatar by choosing from the available assets, such as clothing items, facial features, hair textures, and accessories. Once the user is satisfied with their avatar's appearance, they can save the changes by selecting a save option within the SDK module 430. The SDK module 430 then sends a request to the API module 440, which in turn communicates with the content delivery module 420 to fetch the updated 3D model of the avatar and the selected assets. The content delivery module retrieves the updated 3D avatar model and assets from the content database 410 and delivers them to the SDK module 430. The content database 410 then stores the 3D avatar model and its associated assets for future use. As the user interacts with different 3D rendering platforms 10, they can continue to customize their avatar using the in-engine avatar customization module 14 and the available assets. Any changes made during these sessions are saved and synchronized across platforms through the SDK module 430.

In an embodiment, as illustrated in FIG. 5, the content database 410 and the content delivery module 420 are executed in a server (such as, the server 200). This setup allows for centralized storage and management of the 3D models of avatars, along with their associated first and second assets. The server 200 provides the necessary computational resources and network connectivity to manage the content database 410 effectively and to deliver assets to the SDK module 430 via the content delivery module 420. By executing the content database 410 and the content delivery module 420 on the server 200, the system 400 may efficiently handle multiple requests from different user devices 300 simultaneously, maintaining its performance and responsiveness. The server-based architecture also facilitates easy updates and maintenance for the system 400, as any changes or improvements to the content database 410 or the content delivery module 420 may be implemented on the server-side without requiring updates on the individual user devices 300.

In a specific embodiment, the server 200 is a cloud-based server. Such cloud-based server offers scalability, flexibility, and reliability to efficiently manage the storage and delivery of avatars and associated assets. By utilizing the cloud-based server 200, the content database 410 may store a vast amount of data, including 3D models of avatars, first assets, and second assets, and easily scale its storage capacity as the user base grows. This allows the system 400 to accommodate increasing amounts of data without compromising performance or availability. Further by operating in the cloud-based server 200, the content delivery module 420 may efficiently serve requests from multiple users simultaneously while maintaining low latency and high throughput. In some examples, the content delivery module 420 may be configured to implement an edge server based on a location and/or a bandwidth of the user device 300 for faster delivery to and fetching from the SDK module 430. This cloud-based architecture ensures that the system 400 may effectively manage and deliver avatar data to users across multiple 3D rendering platforms while maintaining optimal performance, security, and scalability.

In an alternate embodiment, the content database 410 and the content delivery module 420 are executed in the user device 300 (not illustrated). With this configuration, the user device takes on the responsibility of locally managing the content database 410 and delivering assets via the content delivery module 420. It may be understood that when the content database 410 and the content delivery module 420 are executed in the user device 300, the system 400 allows for a more decentralized approach to storing and managing the 3D models of avatars, along with their associated assets. By executing the content database 410 and the content delivery module 420 on the user device 300, the system 400 may be able to reduce latency and dependence on server resources, as the data is fetched locally instead of requiring communication with a remote server. Thereby, this approach can improve the responsiveness and performance of the system 400 on the user's end.

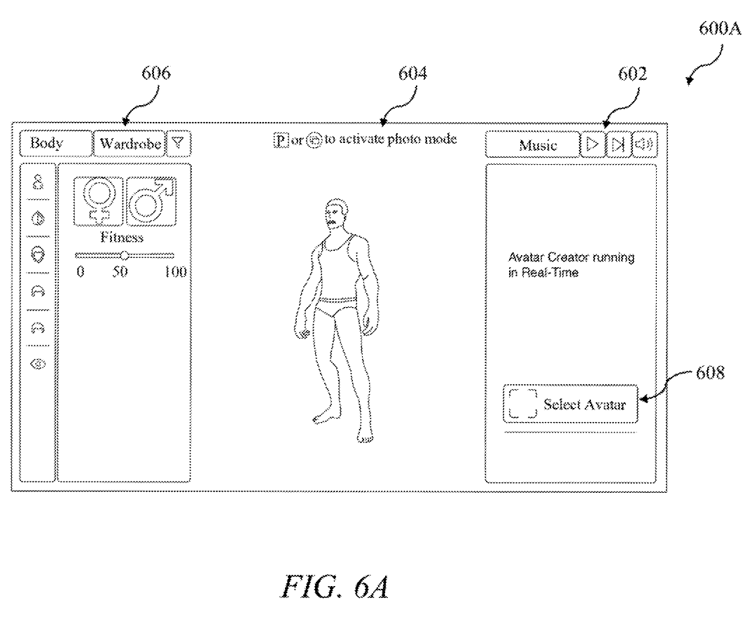

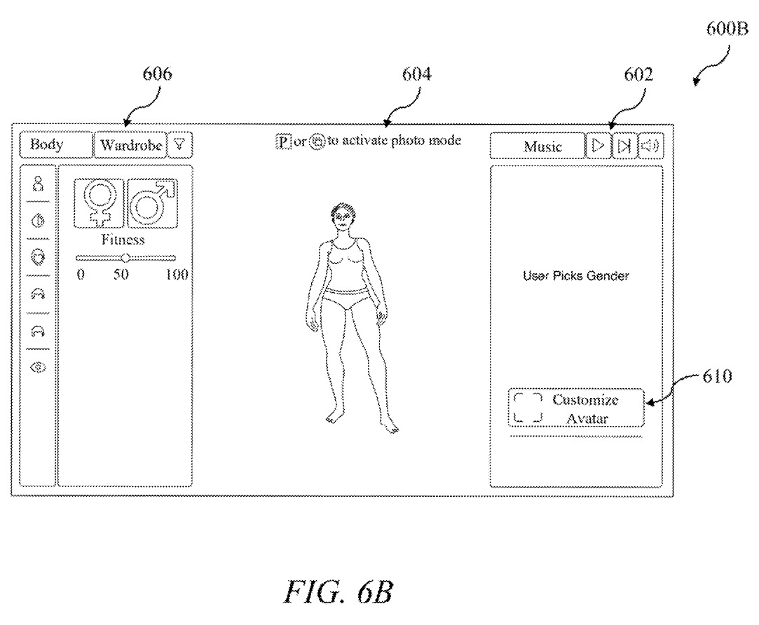

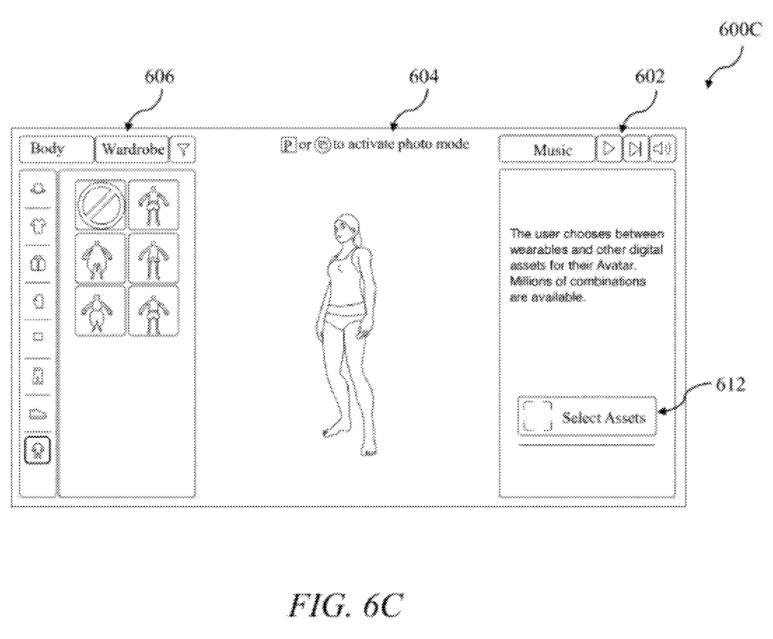

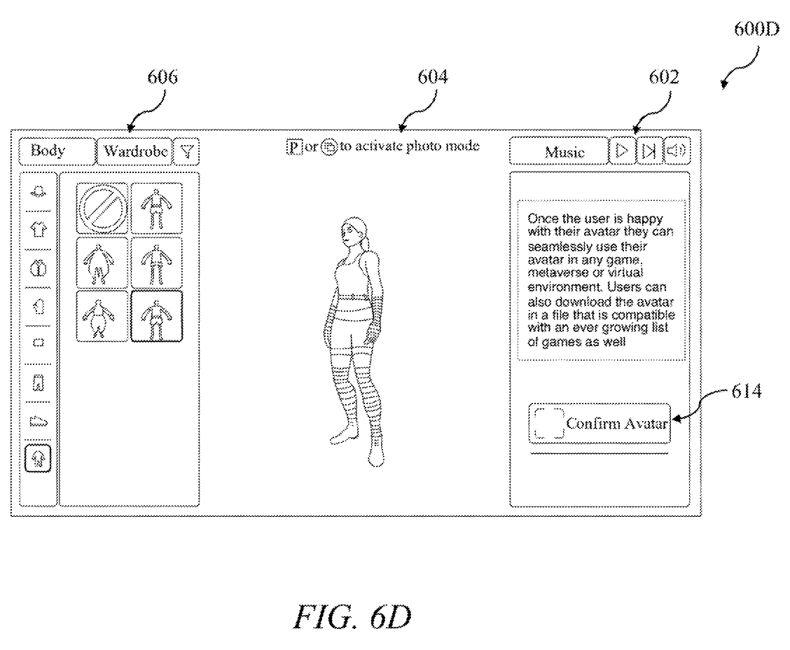

Referring to FIGS. 6A- 6D, illustrated are exemplary depictions of various interfaces which may be implemented to allow the user to manage the avatar as per embodiments of the present disclosure. In particular, FIG. 6A depicts a first interface 600A which provides a dynamic and interactive environment for users to design and customize their avatars in real-time. As users make changes to their avatars, the first interface 600A immediately reflects the alterations, allowing them to visualize their creations without delay. This instant feedback enhances the user experience and promotes a more intuitive and enjoyable avatar design process. In particular, the first interface 600A provides a music panel 602 which allows the users to add music assets to their avatar. The first interface 600A also provides a photo panel 604 which allows the users to add a photo or click a photo (from an associated camera device, like webcam) to customize the avatar accordingly. The first interface 600A further provides a profile panel 606 which allows the users to change profile of the avatar, like selecting gender, changing body type, changing fitness level, adding wardrobe elements, etc. The first interface 600A further provides a Select Avatar button 608 for the user to select the displayed avatar. It may be appreciated that the illustrated first interface 600A is exemplary only and shall not be construed as limiting to the present disclosure in any manner.

FIG. 6B depicts a second interface 600B which enables users to choose the gender of their avatar at the initial stage of the creation process. This choice sets the foundation for the avatar's appearance and informs the subsequent customization options available. By offering a user-friendly interface for gender selection, the system 400 ensures that users may easily create avatars that align with their preferences and identity. The second interface 600B provides a Customize Avatar button 610 for the user to customize the displayed avatar. As soon as the gender selection or any other action related to change in the body profile of the avatar may be completed by the user, the corresponding avatar image may change in the second interface 600B to reflect such action of the user.

FIG. 6C depicts a third interface 600C which allows users to personalize their avatars by selecting from a wide variety of assets including clothing, accessories, hairstyles, and other customizable elements. With numerous possible combinations, users can create a unique avatar that reflects their style and personality. The third interface 600C provides a Select Assets button 612 for the user to select the assets for the avatar. The third interface 600C fosters creativity and self-expression, enhancing the overall avatar creation experience.

FIG. 6D depicts a fourth interface 600D which enables the user to seamlessly use their avatar in the multiple 3D rendering platforms 10. The fourth interface 600D provides a Confirm Avatar button 614 for the user to finalize the displayed avatar. That is, upon finalizing their avatar design, the user can take advantage of the SDK module 430 to effortlessly integrate their avatar into various 3D rendering platforms 10, including games, metaverses, and virtual environments. Additionally, the fourth interface 600D may offer the users the option to download their avatar as an FBX (Filmbox), GLB (GL Binary), GLTF (Graphics Library Transmission Forma), or VRM (Virtual Reality Modeling) file, ensuring compatibility with a wide range of gaming platforms and applications. Thus, the fourth interface 600D empowers users to fully enjoy and utilize their custom avatars across multiple digital environments.

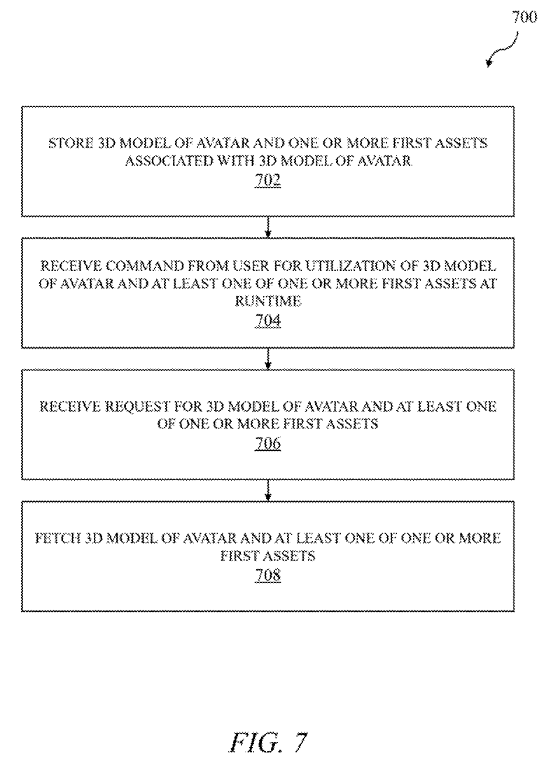

The present disclosure further provides a method for managing an avatar for a user for use in the multiple 3D rendering platforms 10. Referring now to FIG. 7, illustrated is a flowchart for the said method (as represented by reference numeral 700) listing steps involved therein. Various embodiments and variants disclosed above with respect to the system 400 for managing the avatar apply mutatis mutandis to the present method 700. Thus, the details as described above with respect to specific elements have not been repeated herein for brevity of the present disclosure. Also, it may be contemplated that steps (as described hereinafter) for the method 700 are only illustrative and other alternatives can also be provided where one or more steps are added, one or more steps are removed, or one or more steps are provided in a different sequence without departing from the spirit and the scope of the present disclosure.

At step 702, the method 700 includes storing, in the content database, the 3D model of the avatar and the one or more first assets associated with the 3D model of the avatar, as available with the user. This step 702 involves creating a storage system for the user's avatar and its associated assets, ensuring they are readily accessible for future use. At step 704, the method 700 includes receiving a command from the user for utilization, via the SDK module 430 integrated with the in-engine avatar customization module 14 of each one of the multiple 3D rendering platforms 10, of the said 3D model of the avatar and at least one of the said one or more first assets compatible with the corresponding in-engine avatar customization module 14 at the runtime, to customize the avatar. This step 704 involves the user interacting with the SDK module 430 to request the customization of their avatar using the available assets in real-time, which is made possible by integrating the SDK module 430 with the in-engine avatar customization module 14. At step 706, the method 700 includes receiving the first request from the SDK module 430 for the said 3D model of the avatar and the said at least one of the one or more first assets. That is, the first request is received from the SDK module 430 to access the user's avatar and its associated assets. At step 708, the method 700 includes fetching the said 3D model of the avatar and the said at least one of the one or more first assets from the content database 410 in response to the said first request, for delivery to the SDK module 430. Herein, the API module 440 retrieves the requested avatar and assets from the content database 410 and delivers them to the SDK module 430 for use in customizing the avatar.

In one or more embodiments, the method 700 also includes fetching the one or more second assets utilized by the user for customization of the avatar as available in and by implementation of the said corresponding in-engine avatar customization module 14. This step involves accessing additional assets that the user has acquired or created within the 3D rendering platforms. The method 700 further includes receiving the second request from the SDK module 430 for the said one or more second assets for storage in the content database 410. Herein, the API module 440 receives the second request to store the new assets in the content database 410 for future use. The method 700 further includes fetching the said one or more second assets from the SDK module 430 in response to the said second request. Herein, the API module 440 retrieves the new assets from the SDK module 430. The method 700 further includes storing the said one or more second assets in the content database 410. That is, the new assets are stored in the content database 410 alongside the user's avatar and first assets.

In one or more embodiments, the method 700 further includes recording ownership of the 3D model of the avatar, the one or more first assets, and the one or more second assets for the user. This step utilizes the user account module 450 to ensure that users maintain ownership of their avatars and associated assets. For this purpose, the method 700 further includes implementing the distributed ledger 452 for recording the ownership of the 3D model of the avatar, the one or more first assets, and the one or more second assets for the user. The distributed ledger 452, such as a blockchain, is used to record ownership information securely and transparently.

In one or more embodiments, the method 700 further includes deleting duplicate entries of the 3D model of the avatar, the one or more first assets, and the one or more second assets between the multiple 3D rendering platforms 10 in the user device 300. This step optimizes storage by eliminating redundant data across different 3D rendering platforms 10 in the user device 300, for efficient storage.

In an embodiment, the method 700 further includes executing the content database 410 and the content delivery module 420 in the server 200. This ensures that the content database 410 and the content delivery module 420 are hosted on the server 200 for optimal performance and accessibility. In another embodiment, the method 700 further includes executing the content database 410 and the content delivery module 420 in the user device 300. That is, the content database 410 and content delivery module 420 may alternatively be executed within the user device 300, providing a different implementation option that can cater to specific user needs or requirements. This approach may offer advantages such as reduced latency or increased privacy, depending on the specific use case and user preferences.

The present disclosure provides the system 400 and the method 700 for creating and customizing avatars to a granular level that can be used across various games, metaverses, or any other real-time 3D rendered environment. The present disclosure utilizes several technologies, including 3D game engines, in-engine runtime avatar customization systems, remote addressable asset systems, cloud storage, content delivery network, user account databases, multi-application caching systems, and blockchain technology for achieving the said purpose in an efficient manner. The present disclosure allows users to change items while in runtime, enabling users to pick up assets from one game or metaverse and use them in another. Specifically, the present disclosure provides an SDK that allows developers to deploy avatars, wearables, digital items, music, and video into any game, metaverse, or 3D application, and thus provides a seamless experience for the user, allowing them to easily customize and modify their avatars, and enables users to interchange their avatars and assets between games and metaverses as desired. Ownership of assets is stored using blockchain technology, and assets can be added to the catalogue at any time.

The present disclosure offers several advantages over existing solutions. Firstly, the system 400 and the method 700 provide a seamless experience for the user, allowing them to easily interchange their avatars and assets between games and metaverses without the need for manual import and export processes. This saves time and effort for the user, enhancing their overall experience. Secondly, the system 400 and the method 700 offer a more efficient way to manage avatar ownership and associated assets using the distributed ledger 452, which ensures a transparent and decentralized method for managing asset ownership. This can help to prevent disputes and provide users with greater control over their avatars and assets. Lastly, the multi-application caching module 460 helps to optimize resource usage by deleting duplicate entries of avatar and asset data between multiple real-time 3D rendering platforms in the user device 300. This can improve the performance of the system 400 and reduce the amount of storage space required on the user device 300. Overall, the present disclosure provides a more seamless and efficient way to manage avatars and their associated assets for use across multiple real-time 3D rendering platforms 10, addressing the limitations of existing solutions and improving the user experience.

In an aspect, a system for cross-platform delivery and management of a 3D model of an avatar and associated assets is disclosed. The system comprises at least one content delivery module configured to deliver the 3D model of the avatar and associated assets to a plurality of 3D rendering platforms, at least one software development kit (SDK) module configured to interface with an in-engine avatar customization module at a runtime of a 3D rendering platform, at least one multi-application caching module configured to store the 3D model of the avatar and associated assets for reuse across multiple 3D rendering platforms, and at least one content database configured to store the 3D model of the avatar, associated assets, and related metadata.

In an aspect, a computer-implemented method for cross-platform delivery and management of a 3D model of an avatar and associated assets is disclosed. The method comprises delivering, by a content delivery module, the 3D model of the avatar and associated assets to a plurality of 3D rendering platforms. The method further comprises interfacing, by a software development kit (SDK) module, with an in-engine avatar customization module at a runtime of a 3D rendering platform. The method further comprises storing, by a multi-application caching module, the 3D model of the avatar and associated assets for reuse across multiple 3D rendering platforms. The method further comprises storing, in a content database, the 3D model of the avatar, associated assets, and related metadata.

In one or more aspects, the SDK module is configured to fetch one or more second assets utilized by the user for customization of the avatar as available in and by implementation of the corresponding in-engine avatar customization module at the runtime.

In one or more aspects, the multi-application caching module is further configured to consolidate duplicate entries of the avatar and associated assets into a single unified cache entry.

In one or more aspects, the multi-application caching module is further configured to synchronize the unified cache entry with each of the multiple 3D rendering platforms.

In one or more aspects, the multi-application caching module is configured to regularly check for outdated or unused avatar models and assets and remove them from the cache storage.

In one or more aspects, the content database is configured to store metadata associated with each avatar and asset, the metadata comprising at least asset type, asset category, asset creator information, and asset ownership information.

In one or more aspects, the content database supports versioning of avatar assets to enable users to revert to a previous version of the avatar or an asset.

In one or more aspects, the content database includes access control mechanisms comprising at least authentication and encryption to restrict access to avatar data and associated assets.

In one or more aspects, the SDK module is configured to account for differences in how assets are rendered, handled, or animated across different 3D rendering platforms.

In one or more aspects, the method further comprises using a caching mechanism in the content delivery module to store frequently requested 3D models of avatars and assets to reduce access latency.

In one or more aspects, the method further comprises consolidating multiple instances of the same avatar or asset on the user device into a single cache entry using a multi-application caching module.

In one or more aspects, the method further comprises synchronizing a unified cache entry of the avatar and assets across the multiple 3D rendering platforms to maintain consistency.

In one or more aspects, the method further comprises periodically removing unused or outdated avatar models and assets from the user device cache using a multi-application caching module.

In one or more aspects, the method further comprises storing, in the content database, metadata for each avatar and associated asset, the metadata including at least asset type and ownership information.

In one or more aspects, the method further comprises storing multiple versions of an avatar or asset to enable reversion to a prior version.

In one or more aspects, the method further comprises authenticating access to avatar data stored in the content database based on user credentials.

In one or more aspects, the method further comprises adapting the 3D model and associated assets in the SDK module based on specifications of the in-engine avatar customization module.

In one or more aspects, the 3D rendering platforms include at least one of: a video game, a metaverse, or a social virtual reality application, and the user device comprises at least one of: a personal computer, a smartphone, a gaming console, a portable gaming device, a headset, or a heads-up display.

Advanced Embodiments for Destination-Controlled Runtime Enforcement

While the systems that enable a persistent avatar across multiple applications solve the fundamental problem of asset portability, such portability gives rise to new and more complex post-portability challenges. These challenges are particularly acute as interactive systems increasingly include environments created by generative processes. In these dynamic "generative world instances," a "destination" is not a static application but a variable, instance-scoped world with its own unique simulation constraints and compliance policies.

Conventional portability approaches are insufficient for these generative destinations. In particular:
1. Semantic mismatch arises when an asset's functional behavior is incompatible with a destination's simulation envelope.
2. Policy mismatch arises when a destination enforces rules that cannot be expressed via static metadata.
3. Runtime spoofing and replay arise when an attacker modifies an asset after a superficial login check.
4. Instance scope arises when acceptance must be bound to a specific, ephemeral world instance.

Accordingly, there is a need for a destination-controlled acceptance and runtime conformance enforcement framework to solve these post-portability problems. Notably, existing systems lack the architecture to perform instance-specific acceptance or to enforce conformance of an asset's runtime behavior against a cryptographically committed, projected state.

As used in the following descriptions, certain terms have specific meanings. For example, a "generative world instance" or "destination context" refers to a specific, dynamically instantiated environment such as a generated scene, a server shard, or a temporary session, not merely a static game title. A "functional asset" refers to a digital object with associated behaviors, scripts, or physics properties, not just a cosmetic item. A "runtime enforcement gate" refers to a designated enforcement point integrated at the entry point of a core engine subsystem, configured to perform conformance checks.

The foregoing embodiments describe a foundational system for managing and ensuring the portability of avatars and assets. The following description details further embodiments providing a destination-controlled acceptance and runtime conformance enforcement framework that solves post-portability problems in generative environments. A key aspect is the concept of an "instance-specific" destination context, which refers to a specific, dynamically instantiated environment such as a generated scene, a server shard, or a temporary session.

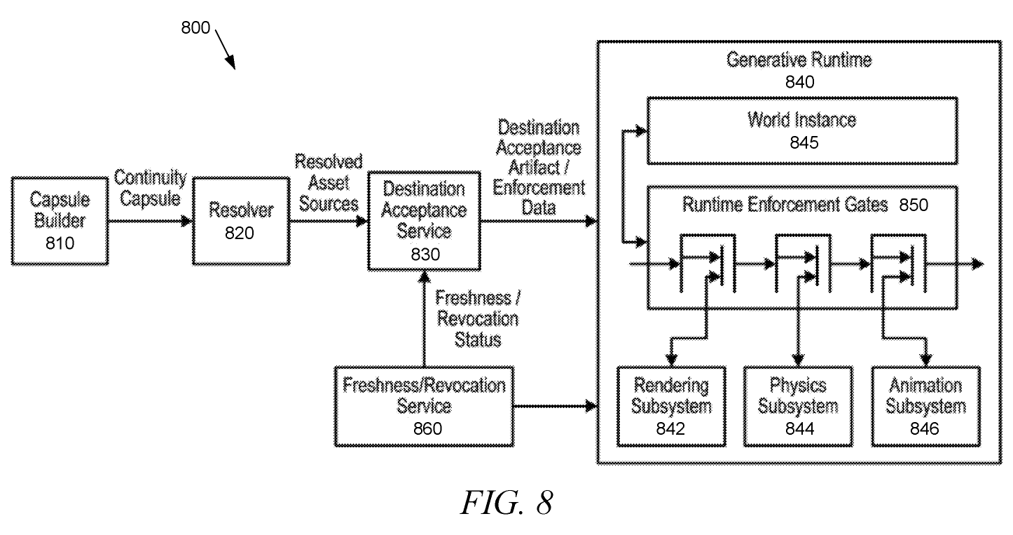

Referring now to FIG. 8, illustrated is an example architecture of a system 800 in accordance with these advanced embodiments. The system 800 includes: a capsule builder 810, configured to construct a continuity capsule; a resolver 820, configured to resolve references to asset sources; a destination acceptance service 830, configured to evaluate the continuity capsule against policies; a generative runtime 840, configured to generate a world instance 845 and enforce acceptance at runtime enforcement gates 850; and an optional freshness/revocation service 860. The generative runtime 840 may include various subsystems, such as a rendering subsystem 842, a physics subsystem 844, and an animation subsystem 846, where the enforcement gates 850 are integrated to prevent unauthorized execution.

In operation, the capsule builder 810 receives identity and asset information from a user or an upstream system and constructs a continuity capsule that encapsulates the user's portable digital identity, character state, and associated functional assets. The continuity capsule serves as a self-contained representation of the user's digital persona and includes cryptographic commitments to the character and asset states, policy constraints, and freshness information. The capsule builder 810 may retrieve asset data from the content database 410 or other asset sources and package this information into a structured format suitable for evaluation by downstream components.

The resolver 820 receives the continuity capsule from the capsule builder 810 and resolves references to asset sources contained within the capsule. When a continuity capsule references assets that may originate from multiple sources, such as a primary game server, a blockchain ledger, or a local inventory, the resolver 820 determines the authoritative source for each referenced asset. The resolver 820 may apply resolution rules based on trust priority, freshness priority, or destination policy to select the appropriate source. Upon successful resolution, the resolver 820 outputs resolved asset sources to the destination acceptance service 830.

The destination acceptance service 830 evaluates the continuity capsule and resolved asset sources against the policies and capabilities of the target destination. The destination acceptance service 830 obtains a destination capability profile that describes the simulation envelopes, action-space constraints, and policy zones of the generative world instance 845. Based on this evaluation, the destination acceptance service 830 performs a deterministic projection that maps the assets and character into destination-compatible representations. The destination acceptance service 830 then generates a destination acceptance artifact that binds cryptographic commitments of the projected asset states to the specific world instance 845 and may include freshness fields to prevent replay attacks. The destination acceptance artifact and associated enforcement data are provided to the generative runtime 840.

The freshness/revocation service 860 communicates with the destination acceptance service 830 to provide freshness and revocation status information. This service enables the system 800 to invalidate previously issued acceptance artifacts when necessary, such as when an asset is revoked or when the destination context mutates. The freshness/revocation service 860 may issue short-lived freshness seals that allow for offline validation within a defined revocation window.

The generative runtime 840 generates and manages the world instance 845 and enforces the destination acceptance artifact at the runtime enforcement gates 850. The runtime enforcement gates 850 are integrated at the entry points of core engine subsystems, including the rendering subsystem 842, the physics subsystem 844, and the animation subsystem 846. Each runtime enforcement gate 850 validates the destination acceptance artifact before permitting a protected operation to proceed. The validation includes verifying that the parameters of an invoked operation conform to the cryptographic commitments within the destination acceptance artifact. This deep integration into engine subsystems ensures that enforcement occurs at the last possible moment before a protected operation is executed, providing security against runtime spoofing and parameter tampering that would bypass conventional one-time login checks.

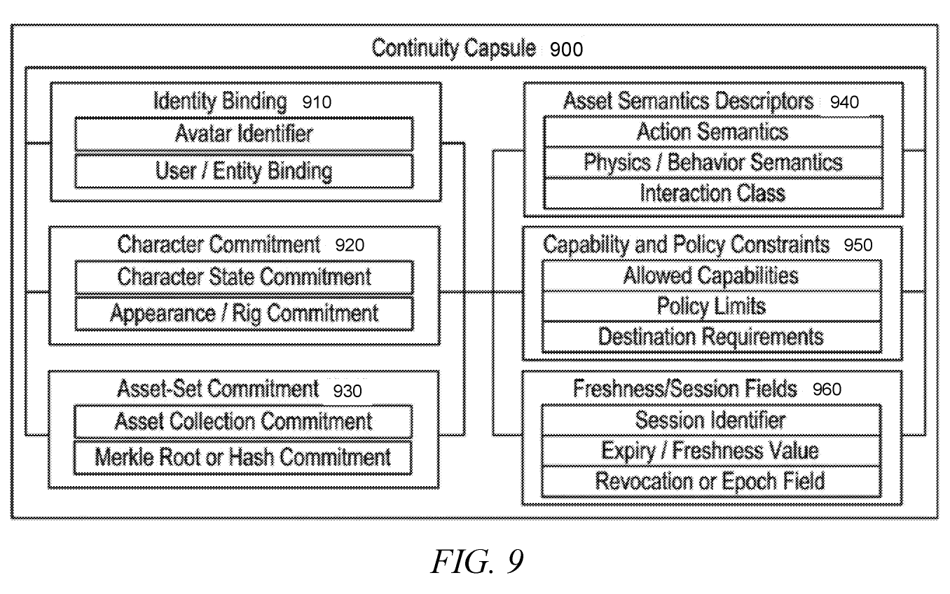

Referring now to FIG. 9, an example continuity capsule 900 is illustrated as a portable data structure. It includes an identity binding 910, a character commitment 920, an asset-set commitment 930, asset semantics descriptors 940, capability and policy constraints 950, and freshness/session fields 960. These components collectively define the portable identity and its associated permissions and technical requirements.

The identity binding 910 establishes the association between the continuity capsule 900 and a specific user or entity. The identity binding 910 includes an avatar identifier that uniquely identifies the portable avatar within the system and a user/entity binding that cryptographically links the avatar to its owner. This binding ensures that the continuity capsule 900 cannot be fraudulently claimed by unauthorized parties and provides a foundation for ownership verification throughout the acceptance and enforcement process.

The character commitment 920 contains cryptographic commitments to the character's state and visual representation. The character commitment 920 includes a character state commitment that captures the current state of the character, such as attributes, progression data, or configuration settings, and an appearance/rig commitment that commits to the visual and skeletal representation of the character. By including these commitments, the continuity capsule 900 enables destination systems to verify that the character presented at runtime matches the character that was evaluated during the acceptance process.

The asset-set commitment 930 provides a cryptographic commitment to the collection of assets associated with the portable identity. The asset-set commitment 930 includes an asset collection commitment that identifies the set of assets included in the capsule and a Merkle root or hash commitment that enables efficient verification of asset membership. The use of a Merkle structure allows runtime enforcement gates to verify that a specific asset belongs to the accepted set without requiring transmission of the entire asset list, thereby reducing verification overhead during runtime operations.

The asset semantics descriptors 940 describe the functional behaviors and interaction capabilities of the assets within the continuity capsule 900. The asset semantics descriptors 940 include action semantics that define what actions an asset can perform, physics/behavior semantics that describe how an asset interacts with simulation systems, and an interaction class that categorizes the type of interactions the asset supports. These descriptors enable destination systems to evaluate whether an asset's functional behavior is compatible with the destination's simulation envelope during the projection process.

The capability and policy constraints 950 define the permissions and restrictions that govern how the identity and assets may operate within destination environments. The capability and policy constraints 950 include allowed capabilities that specify what operations the identity is permitted to perform, policy limits that define boundaries on asset behavior, and destination requirements that specify conditions a destination may satisfy for the capsule to be accepted. These constraints enable the continuity capsule 900 to carry policy information that can be evaluated against destination capability profiles.

The freshness/session fields 960 provide temporal validity information and enable revocation mechanisms for the continuity capsule 900. The freshness/session fields 960 include a session identifier that uniquely identifies the current session, an expiry/freshness value that indicates when the capsule's validity expires, and a revocation or epoch field that enables the system to invalidate capsules when necessary. These fields prevent replay attacks by ensuring that acceptance artifacts are bound to specific temporal contexts and can be revoked when conditions change.

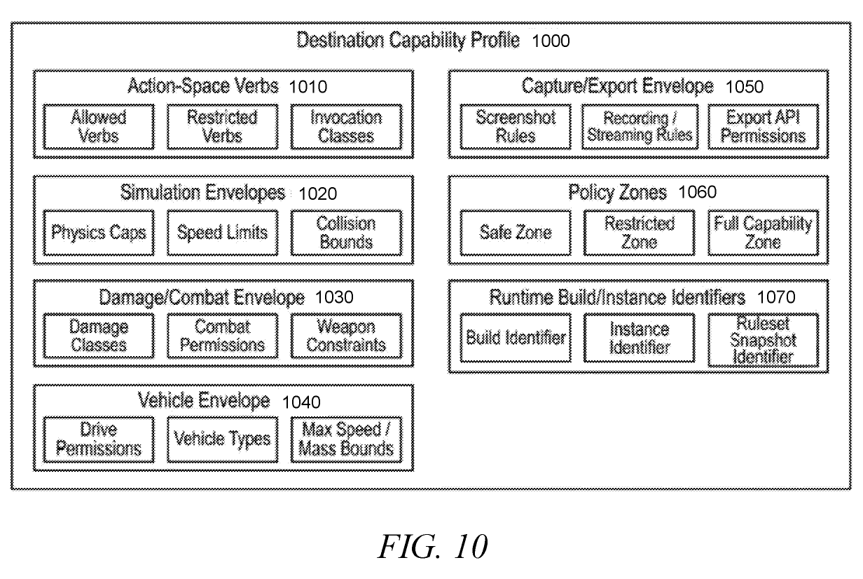

Referring now to FIG. 10, an example destination capability profile 1000 is illustrated. This profile 1000 describes the capabilities of a destination world instance and includes: action-space verbs 1010, simulation envelopes 1020 (e.g., physics caps), a damage/combat envelope 1030, a vehicle envelope 1040, a capture/export envelope 1050, policy zones 1060, and runtime build/instance identifiers 1070.

The action-space verbs 1010 define the permitted and restricted actions within the destination. The action-space verbs 1010 comprise allowed verbs that specify operations a portable identity may invoke, restricted verbs that identify operations that are prohibited or limited within the destination context, and invocation classes that categorize actions by type or severity. By enumerating the action-space verbs 1010, the destination capability profile 1000 enables the destination acceptance service 830 to determine whether the actions associated with incoming assets are compatible with the destination's operational constraints.

The simulation envelopes 1020 define the physics and simulation constraints of the destination. The simulation envelopes 1020 comprise physics caps that establish upper bounds on physical parameters such as mass, velocity, or force, speed limits that constrain movement rates within the simulation, and collision bounds that govern how objects interact during collision events. These envelopes ensure that assets with physics properties operate within the destination's simulation parameters, preventing assets from exhibiting behaviors that would disrupt the simulation or provide unfair advantages.

The damage/combat envelope 1030 specifies combat-related constraints within the destination. The damage/combat envelope 1030 comprises damage classes that categorize types of damage permitted within the destination, combat permissions that define whether and how combat interactions are allowed, and weapon constraints that limit the characteristics of weapons that may be used. This envelope enables destinations to enforce combat rules appropriate to their context, such as restricting lethal damage in social spaces or limiting weapon types in competitive environments.

The vehicle envelope 1040 defines vehicle-related parameters for the destination. The vehicle envelope 1040 comprises drive permissions that specify whether vehicle operation is permitted, vehicle types that enumerate the categories of vehicles allowed, and max speed/mass bounds that constrain vehicle performance characteristics. By including the vehicle envelope 1040, the destination capability profile 1000 enables enforcement of vehicle-specific rules that may differ from general physics constraints.

The capture/export envelope 1050 governs content capture and export operations within the destination. The capture/export envelope 1050 comprises screenshot rules that define permissions for capturing still images, recording/streaming rules that govern video capture and live streaming, and export API permissions that control programmatic access to content export functionality. This envelope enables destinations to protect intellectual property, enforce privacy requirements, or restrict content distribution as appropriate to their policies.

The policy zones 1060 define different regions within the destination with varying rule sets. The policy zones 1060 comprise safe zone designations where certain capabilities may be restricted, restricted zone designations where additional limitations apply, and full capability zone designations where all permitted operations are available. By partitioning the destination into policy zones 1060, the destination capability profile 1000 enables fine-grained, location-based enforcement of different rules within a single world instance.

The runtime build/instance identifiers 1070 uniquely identify the specific destination instance. The runtime build/instance identifiers 1070 comprise a build identifier that specifies the version of the destination software, an instance identifier that uniquely identifies the particular world instance, and a ruleset snapshot identifier that captures the specific policy configuration in effect. These identifiers bind the destination capability profile 1000 to a specific, dynamically instantiated generative world instance, ensuring that acceptance artifacts are valid for the intended destination context.

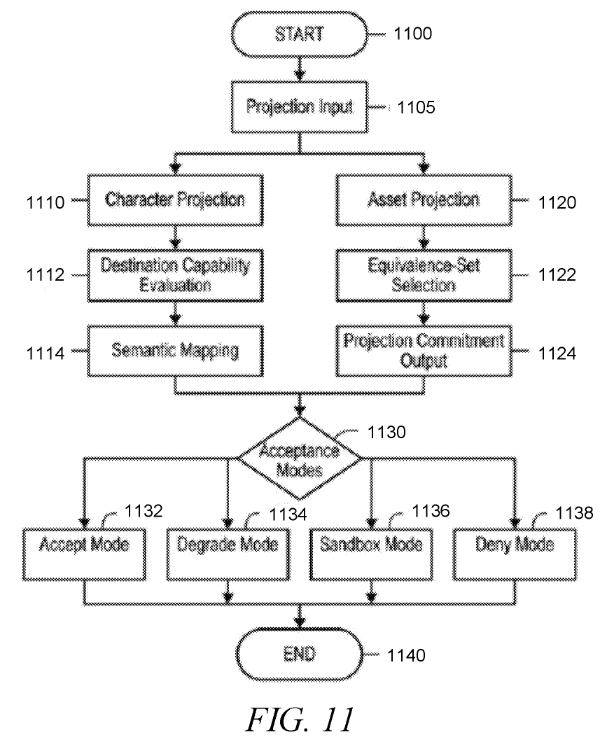

Referring now to FIG. 11, a deterministic projection pipeline is illustrated. This process transforms a character and assets into a destination-compatible representation. The pipeline includes, inter alia, an operation 1110 for character projection and an operation 1120 for asset projection, resulting in various acceptance modes 1130 such as accept, degrade, sandbox, or deny.

The deterministic projection pipeline begins at step 1100, which represents the start of the process. The process proceeds to step 1105, where projection input is received. This input may include a continuity capsule 900 containing the character and asset information, along with the destination capability profile 1000 that defines the constraints of the target destination.

From step 1105, the pipeline branches into two parallel processing paths. The first path handles character projection at operation 1110. Character projection evaluates the character's state and visual representation against the destination's requirements. The character projection path proceeds to step 1112 for destination capability evaluation, where the character's attributes and behaviors are compared against the action-space verbs 1010 and simulation envelopes 1020 defined in the destination capability profile 1000. Subsequently, the path continues to step 1114 for semantic mapping, where the character's functional semantics are mapped to destination-compatible equivalents.

The second parallel path handles asset projection at operation 1120. Asset projection processes each asset within the asset-set commitment 930 to determine its compatibility with the destination. The asset projection path proceeds to step 1122 for equivalence-set selection, where the system identifies whether substitute assets from predefined equivalence sets should be used when a primary asset is incompatible. The path then continues to step 1124 for projection commitment output, where cryptographic commitments to the projected asset states are generated for inclusion in the destination acceptance artifact.

Both processing paths converge at acceptance modes 1130, which represents a decision point for determining the appropriate acceptance mode for each projected element. The acceptance mode determination evaluates the results of the character and asset projections against the destination's policies and constraints.

From acceptance modes 1130, the process can proceed to one of four acceptance modes. Accept mode 1132 can permit the asset or character to be used in its original or minimally modified form when full compatibility is established. Degrade mode 1134 can allow the asset or character to be used in a reduced or modified form when certain parameters exceed destination constraints but can be clamped or adjusted to conform. Sandbox mode 1136 can restrict the asset or character to limited functionality or specific zones within the destination when full operation would violate policies, but constrained operation is permissible. Deny mode 1138 can block the asset or character from being used in the destination when no acceptable projection can be achieved.

Each of the acceptance modes ultimately leads to step 1140, which represents the end of the pipeline. The outputs of the deterministic projection pipeline, including the projected representations and their associated acceptance modes, are then used to construct the destination acceptance artifact that will govern runtime enforcement.

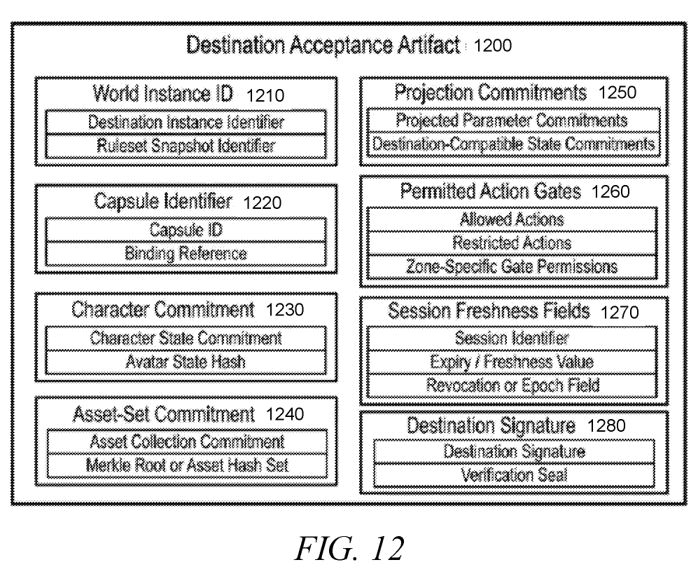

Referring now to FIG. 12, the structure of an example destination acceptance artifact (DAA) 1200 is shown. The DAA 1200 binds various data, including a world instance ID 1210, a capsule identifier 1220, a character commitment 1230, an asset-set commitment 1240, projection commitments 1250, permitted action gates 1260, session freshness fields 1270, and a destination signature 1280. This DAA 1200 serves as a temporary, verifiable "visa" for the asset within the runtime. The inclusion of the projection commitments 1250 is technically advantageous as it enables the runtime gates to perform conformance checking rather than simple permission validation, thereby preventing runtime parameter tampering.

The world instance ID 1210 binds the DAA 1200 to a specific, dynamically instantiated destination context. The world instance ID 1210 comprises a destination instance identifier that uniquely identifies the particular world instance and a ruleset snapshot identifier that captures the specific policy configuration in effect at the time of acceptance. By including the world instance ID 1210, the DAA 1200 ensures that the acceptance is valid for the intended destination context and cannot be replayed against a different world instance or a mutated version of the same instance.

The capsule identifier 1220 associates the DAA 1200 with a particular continuity capsule 900. The capsule identifier 1220 comprises a capsule ID that uniquely identifies the continuity capsule and a binding reference that links the artifact to the specific version of the capsule that was evaluated during the acceptance process. This association enables the system to verify that the DAA 1200 corresponds to the correct portable identity and asset collection.

The character commitment 1230 provides a cryptographic commitment to the character's projected state within the destination. The character commitment 1230 comprises a character state commitment that captures the accepted state of the character and an avatar state hash that commits to the visual and functional representation of the character as projected for the destination. By including the character commitment 1230, the DAA 1200 enables runtime enforcement gates to verify that the character presented during runtime matches the character that was evaluated and accepted during the projection process.

The asset-set commitment 1240 enables verification of asset membership and integrity during runtime operations. The asset-set commitment 1240 comprises an asset collection commitment that identifies the set of assets included in the acceptance and a Merkle root or asset hash set that enables efficient verification of individual asset membership. The use of a Merkle structure allows runtime enforcement gates to verify that a specific asset belongs to the accepted set without requiring transmission of the entire asset list, thereby reducing verification overhead during runtime operations.

The projection commitments 1250 contain cryptographic commitments to the projected parameters of the accepted assets and character. The projection commitments 1250 comprise projected parameter commitments that bind the specific parameter values resulting from the deterministic projection process and destination-compatible state commitments that capture the transformed asset states. The inclusion of the projection commitments 1250 enables runtime enforcement gates to perform conformance checking by verifying that the parameters of an invoked operation match the committed projected values, thereby preventing runtime parameter tampering that would bypass the acceptance process.

The permitted action gates 1260 specify the operations that are authorized for the associated assets within the destination context. The permitted action gates 1260 comprise allowed actions that enumerate the operations the identity may invoke, restricted actions that identify operations that are prohibited or limited, and zone-specific gate permissions that define location-dependent authorization rules. By including the permitted action gates 1260, the DAA 1200 provides runtime enforcement gates with the information necessary to determine whether a requested operation should be permitted or denied.

The session freshness fields 1270 enable temporal validation and revocation checking for the DAA 1200. The session freshness fields 1270 comprise a session identifier that uniquely identifies the current session, an expiry or freshness value that indicates when the artifact's validity expires, and a revocation or epoch field that enables the system to invalidate artifacts when necessary. These fields prevent replay attacks by ensuring that the DAA 1200 is bound to a specific temporal context and can be revoked when conditions change or when the destination context mutates.

The destination signature 1280 provides cryptographic authentication of the DAA 1200 by the destination system. The destination signature 1280 comprises a destination signature that cryptographically signs the contents of the artifact and a verification seal that enables runtime enforcement gates to verify the authenticity and integrity of the artifact. By including the destination signature 1280, the DAA 1200 ensures that the artifact was issued by an authorized destination system and has not been tampered with since issuance.

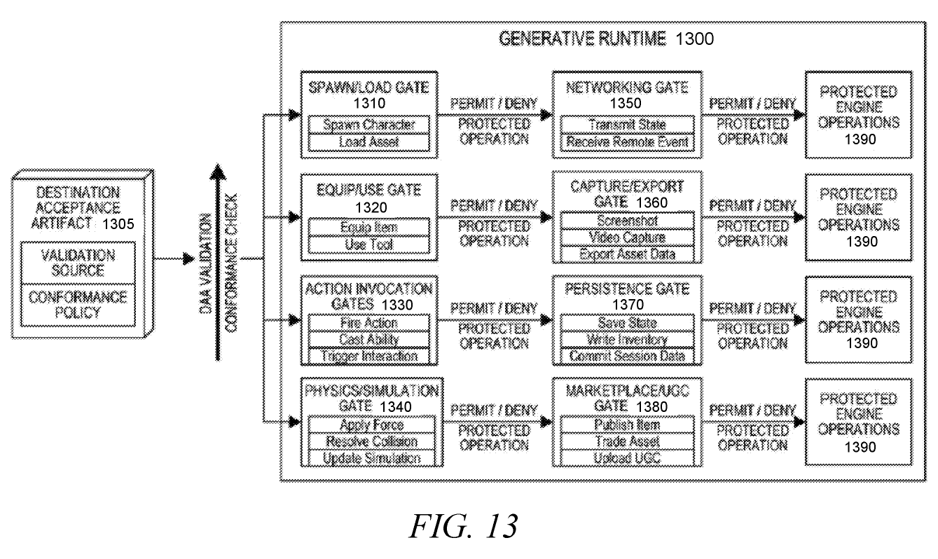

Referring now to FIG. 13, the integration of example runtime enforcement gates into various engine subsystems of an example generative runtime 1300 is depicted. The example runtime enforcement gates include, but are not limited to, a spawn/load gate 1310, an equip/use gate 1320, action invocation gates 1330, a physics/simulation gate 1340, a networking gate 1350, a capture/export gate 1360, a persistence gate 1370, and a marketplace/UGC gate 1380. Each gate validates the DAA before allowing a corresponding low-level operation to proceed.

As used herein, a 'gate' or 'runtime enforcement gate' refers to a designated enforcement point within the software architecture of the generative runtime, typically integrated at the entry point of a core engine subsystem (such as a physics, animation, or spawning subsystem), which is configured to perform validation and conformance checks against a destination acceptance artifact before allowing a protected operation to proceed. This deep integration into engine subsystems is a key technical feature, as it allows enforcement to occur at the last possible moment before a protected operation is executed, providing a more secure and reliable solution than conventional one-time, login-based checks.

The generative runtime 1300 receives a destination acceptance artifact 1305 which includes validation source and conformance policy information. The destination acceptance artifact 1305 undergoes a DAA validation and conformance check process before being distributed to the multiple enforcement gates within the generative runtime 1300.

The spawn/load gate 1310 is configured to handle spawn character and load asset operations. When a request is made to spawn a character or load an asset into the generative world instance, the spawn/load gate 1310 validates the destination acceptance artifact 1305 to verify that the character or asset is authorized for instantiation within the destination context. The spawn/load gate 1310 performs permit or deny decisions for these protected operations before allowing execution to proceed to the protected engine operations 1390.

The equip/use gate 1320 handles equip item and use tool operations. When a user attempts to equip an item to their character or use a tool within the environment, the equip/use gate 1320 validates the destination acceptance artifact 1305 to confirm that the requested operation conforms to the permitted action gates 1260 and projection commitments 1250 contained within the artifact. The equip/use gate 1320 similarly performs permit or deny decisions for these protected operations.

The action invocation gates 1330 are configured to process fire action, cast ability, and trigger interaction operations. These gates represent enforcement points for functional behaviors associated with assets, such as firing a weapon, casting an ability, or triggering an environmental interaction. The action invocation gates 1330 verify that the parameters of the invoked action conform to the cryptographic commitments within the destination acceptance artifact 1305, thereby preventing runtime parameter tampering.

The physics/simulation gate 1340 handles apply force, resolve collision, and update simulation operations. This gate ensures that physics interactions involving portable assets operate within the simulation envelopes 1020 defined by the destination capability profile 1000. The physics/simulation gate 1340 validates that parameters such as mass, velocity, and force values conform to the projected parameter commitments before permitting physics calculations to proceed.

The networking gate 1350 processes transmit state and receive remote event operations. This gate governs network communications related to portable assets, ensuring that state transmissions and remote event handling conform to the destination acceptance artifact 1305. The networking gate 1350 prevents unauthorized state propagation or manipulation through network channels.

The capture/export gate 1360 handles screenshot, video capture, and export asset data operations. This gate enforces the capture/export envelope 1050 defined in the destination capability profile 1000, controlling whether content capture and export operations are permitted based on the policy constraints within the destination acceptance artifact 1305.

The persistence gate 1370 processes save state, write inventory, and commit session data operations. This gate ensures that persistence operations involving portable assets conform to the destination acceptance artifact 1305, preventing unauthorized modification of saved state or inventory data.

The marketplace/UGC gate 1380 handles publish item, trade asset, and upload UGC operations. This gate governs marketplace and user-generated content functionality, ensuring that trading, publishing, and content upload operations conform to the permitted action gates 1260 within the destination acceptance artifact 1305.

Each of the gates connects to protected engine operations 1390 upon successful validation. The protected engine operations 1390 represent the actual engine subsystem operations that are permitted to execute after the corresponding gate has verified conformance with the destination acceptance artifact 1305. This architecture ensures that operations associated with assets are validated against the cryptographic commitments within the destination acceptance artifact 1305 before execution proceeds, providing security against runtime spoofing and parameter tampering that would bypass conventional one-time login checks.

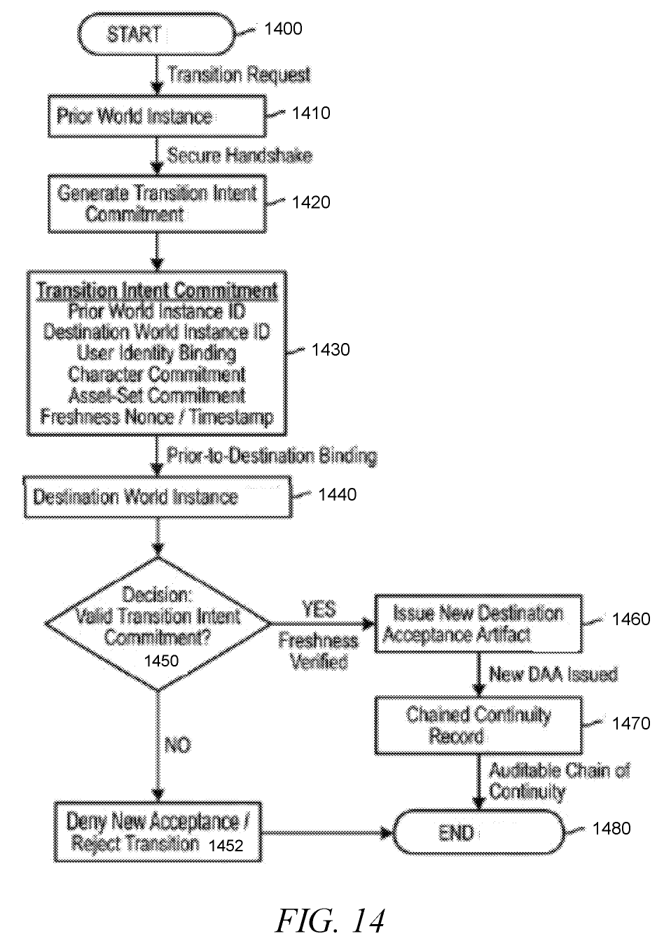

Referring now to FIG. 14, the process of ensuring cross-instance continuity for transitions between different generative world instances is shown. In general, to prevent unauthorized "forking" of a character's state or replay-based continuity claims, the system may generate a transition intent commitment 1430. This commitment 1430 serves as a secure handshake between the prior world instance and the destination world instance. It binds together critical data, including: the prior world instance ID, the destination world instance ID, the user's identity binding, the character commitment, the asset-set commitment, and a freshness nonce or timestamp. A destination may require this valid transition intent commitment 1430 before it agrees to issue a new destination acceptance artifact (DAA) at step 1460 for its own world, thereby creating a secure, auditable chain of continuity.

Referring to FIG. 14 in greater detail, the flowchart illustrates a method for cross-instance continuity between generative world instances using transition intent commitments and chained acceptance artifacts. The method begins at step 1400, which represents the start of the cross-instance continuity process. At step 1410, a transition request is initiated to a prior world instance, signaling the user's intent to move their portable identity and assets to a different destination context.

The process proceeds to step 1420, where a secure handshake between the prior world instance and the intended destination establishes the foundation for generating a transition intent commitment. The resulting transition intent commitment 1430 can comprise a data structure that binds together several critical elements: the prior world instance ID, the destination world instance ID, the user's identity binding, the character commitment, the asset-set commitment, and a freshness nonce or timestamp. This binding establishes a prior-to-destination relationship that cryptographically links the user's state in the prior world to their intended state in the destination world.

At step 1440, the destination world instance receives the transition intent commitment 1430 from the prior world instance. The destination world instance then evaluates the received commitment to determine its validity. At step 1450, a decision is made to determine whether the transition intent commitment is valid. This decision includes verification of the freshness nonce or timestamp to ensure that the commitment has not expired and is not being replayed from a previous session.

If the transition intent commitment is determined to be invalid at step 1450, the process proceeds along the NO branch to step 1452, where new acceptance is denied and the transition is rejected. This rejection prevents unauthorized forking of a character's state or replay-based continuity claims, ensuring that legitimate transitions are permitted.

If the transition intent commitment is determined to be valid at step 1450, the process proceeds along the YES branch to step 1460, where a new destination acceptance artifact is issued by the destination world instance. This new destination acceptance artifact is bound to the specific destination context and includes the cryptographic commitments necessary for runtime enforcement within the new world instance.

Following the issuance of the new destination acceptance artifact at step 1460, the process moves to step 1470, where a chained continuity record is created. This chained continuity record establishes an auditable chain of continuity that links the user's prior world instance to their current destination world instance. The chained continuity record enables verification of the user's transition history and provides an audit trail for tracking the movement of portable identities and assets across multiple generative world instances.

The process concludes at step 1480, representing the end of the cross-instance continuity method. Upon completion, the user's portable identity and assets are now governed by the newly issued destination acceptance artifact within the destination world instance, and the runtime enforcement gates within that instance will enforce conformance based on the new artifact's commitments and permissions.

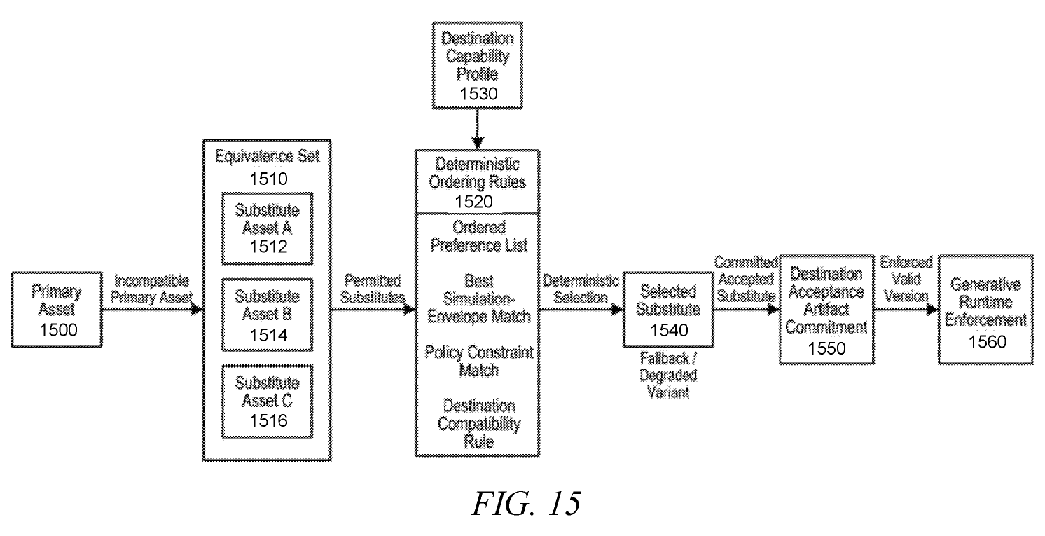

Referring now to FIG. 15, the concept of equivalence sets and deterministic fallback is illustrated. In general, for any given primary asset 1500, the continuity capsule may specify an equivalence set 1510 of permitted substitutes. When the primary asset 1500 is incompatible with a destination capability profile 1530, the destination system can deterministically select a substitute from the equivalence set 1510. This selection is based on a predefined set of deterministic ordering rules 1520, such as an ordered preference list, the best match for the destination's simulation envelope, or other policy constraints. A selected substitute 1540 can be recorded or committed to within a DAA commitment 1550, so that generative runtime enforcement 1560 can enforce its use as the valid, degraded, or fallback version of the original asset.

Referring to FIG. 15 in greater detail, the flowchart illustrates the process by which asset equivalence sets and deterministic fallback ordering enable substitutions and degraded variants when a primary asset is incompatible with a destination. The primary asset 1500 represents the original asset that a user intends to bring into a destination context. Associated with the primary asset 1500 is an equivalence set 1510, which contains multiple permitted substitutes including substitute asset A 1512, substitute asset B 1514, and substitute asset C 1516. These substitute assets are predefined alternatives that can serve as replacements when the primary asset 1500 cannot be used directly within the destination environment.

When the primary asset 1500 is determined to be incompatible with the destination, the system references deterministic ordering rules 1520 to select an appropriate replacement from the equivalence set 1510. The deterministic ordering rules 1520 receive input from a destination capability profile 1530, which provides information about the destination's simulation envelopes, policy constraints, and compatibility requirements. Based on this input, the deterministic ordering rules 1520 generate an ordered preference list that ranks the substitute assets according to criteria such as best simulation-envelope match, policy constraint match, and destination compatibility rules.

The deterministic ordering rules 1520 identify permitted substitutes from the equivalence set 1510 and perform a deterministic selection process. This deterministic approach ensures that the same input conditions will always produce the same selection outcome, providing predictability and consistency across different sessions and instances. The output of this selection process is a selected substitute 1540, which may be either a committed accepted substitute that closely matches the original asset's functionality or a fallback or degraded variant that provides reduced functionality while maintaining compatibility.

The selected substitute 1540 proceeds to a destination acceptance artifact commitment 1550, where the selection is recorded and cryptographically committed. This commitment ensures that the enforced version of the asset is documented within the destination acceptance artifact, enabling runtime enforcement gates to verify that the correct substitute is being used. The destination acceptance artifact commitment 1550 then feeds into generative runtime enforcement 1560, which ensures that the selected substitute is properly enforced during runtime operations.

This architecture provides several technical advantages. By predefining equivalence sets within the continuity capsule, the system enables graceful degradation when assets cannot be used in their original form. The deterministic nature of the selection process prevents ambiguity and ensures that all parties agree on which substitute should be used. Furthermore, by committing the selected substitute within the destination acceptance artifact, the system maintains the integrity of the enforcement framework, ensuring that runtime enforcement gates can verify that the asset being used matches the accepted substitute rather than an unauthorized alternative.

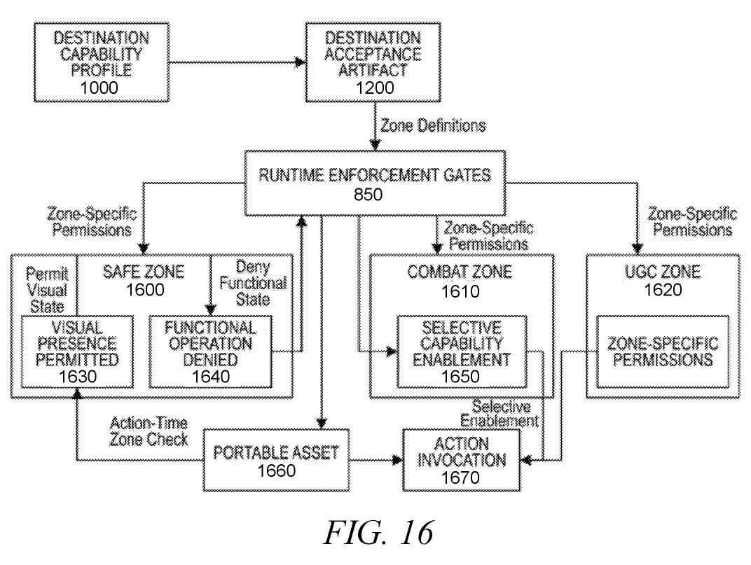

Referring now to FIG. 16, an example mechanism for zone-based enforcement is depicted. A destination may be partitioned into different policy zones, such as "safe zones," "combat zones," or "UGC zones." A destination capability profile can define these zones, and the DAA 1200 can then carry zone-specific permissions for a character or asset. The runtime enforcement gates 850 can be configured to apply zone checks at the moment of action invocation. This enables fine-grained control, such as the example shown where an asset is permitted to exist visually (e.g., a weapon is visible on a player's back) but is denied a functional operation (e.g., the firing action is blocked) while inside a designated safe zone.

Referring to FIG. 16 in greater detail, the diagram illustrates how zone-based enforcement enables differentiated policy application across distinct regions within a generative world instance. The destination capability profile 1000 defines multiple policy zones including a safe zone 1600, a combat zone 1610, and a UGC zone 1620. These zone definitions, together with the DAA 1200, provide zone-specific permissions to the runtime enforcement gates 850, which then distribute appropriate permissions to each policy zone.

Within the safe zone 1600, the zone-specific permissions result in a bifurcated enforcement state for a portable asset 1660. The visual presence permitted 1630 state allows the portable asset 1660 to be rendered and displayed within the safe zone 1600, meaning that a weapon or other functional item remains visible on the user's character. However, the functional operation denied 1640 state simultaneously prevents the portable asset 1660 from executing its associated functional behaviors. This separation between visual representation and functional capability enables destinations to maintain aesthetic continuity for users while enforcing safety policies that restrict potentially disruptive actions within designated areas.

The combat zone 1610 receives zone-specific permissions that enable selective capability enablement 1650. Within this zone, the selective capability enablement 1650 provides authorization for an action invocation 1670, allowing the portable asset 1660 to execute its full range of functional operations. When a user attempts to invoke an action, the portable asset 1660 undergoes an action-time zone check that evaluates the current zone context before the action invocation 1670 proceeds. This real-time zone evaluation ensures that the appropriate permissions are applied based on the user's current location within the destination.

The UGC zone 1620 similarly receives zone-specific permissions that govern user-generated content areas, where different policy constraints may apply regarding content creation, modification, and interaction capabilities.

This zone-based architecture enables destinations to implement nuanced policy enforcement that varies spatially within a single world instance, providing flexibility to accommodate different gameplay contexts, social spaces, and content creation areas while maintaining consistent enforcement through the runtime enforcement gates 850.

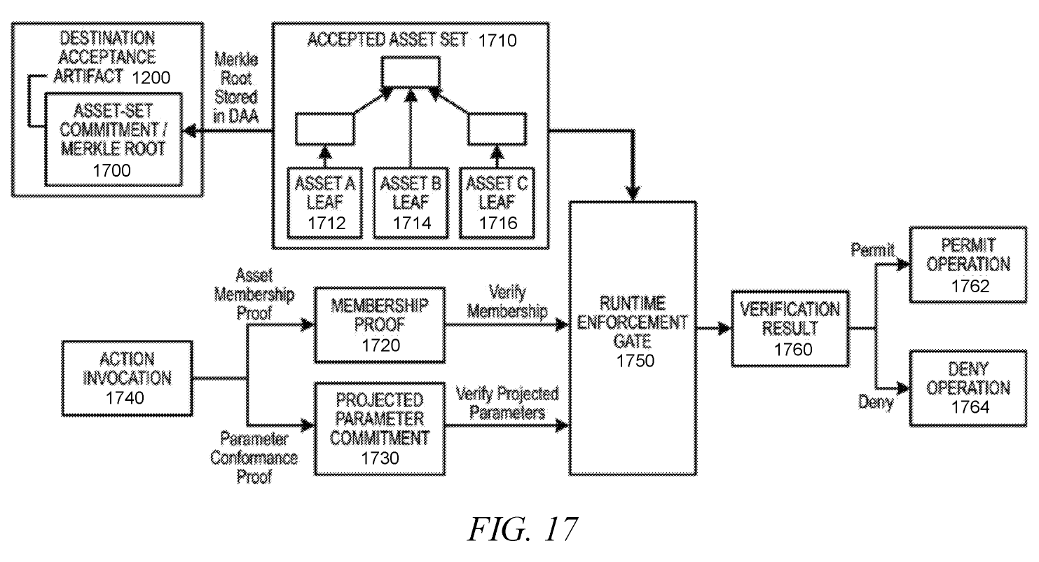

Referring now to FIG. 17, the use of Merkle-committed asset proofs to reduce runtime overhead is illustrated. The asset-set commitment within the DAA 1200 may be structured as a Merkle root 1700 calculated over the set of accepted assets. At the time of an action invocation 1740 (e.g., firing a weapon), the client or subsystem does not need to send the entire list of assets for verification. Instead, it provides a membership proof 1720 (i.e., a Merkle proof) for the specific asset being used. A runtime enforcement gate 1750 can efficiently verify this membership proof 1720 against the Merkle root 1700 stored in the DAA 1200. Optionally, the membership proof 1720 can also include a projected parameter commitment 1730, which is a commitment to the asset's projected parameters, allowing the runtime enforcement gate 1750 to verify both asset membership and parameter conformance in a single, efficient operation.

Referring to FIG. 17 in greater detail, the diagram illustrates a system for Merkle-committed asset-set acceptance and per-asset authorization proofs used at action-gates. The DAA 1200 contains an asset-set commitment Merkle root 1700, which stores a Merkle root derived from an accepted asset set 1710. The accepted asset set 1710 comprises a hierarchical tree structure with individual asset leaves including an asset A leaf 1712, an asset B leaf 1714, and an asset C leaf 1716. These asset leaves form the basis of the Merkle tree, with intermediate nodes connecting them to the root stored in the asset-set commitment Merkle root 1700.

When an action invocation 1740 occurs, such as firing a weapon or using a tool, the system generates two types of proofs for verification. An asset membership proof is provided as a membership proof 1720, which demonstrates that a specific asset belongs to the accepted asset set 1710 by providing a path through the Merkle tree to the root. This membership proof 1720 can include the sibling hashes along the path from the asset leaf to the Merkle root, enabling efficient verification without transmitting the entire asset list. Additionally, a parameter conformance proof is provided as a projected parameter commitment 1730, which contains commitments to the projected parameters of the asset being used. The projected parameter commitment 1730 enables verification that the asset's runtime parameters conform to the values that were accepted during the projection process.

Both the membership proof 1720 and the projected parameter commitment 1730 are submitted to a runtime enforcement gate 1750. The runtime enforcement gate 1750 performs two verification operations. First, it verifies membership by checking the membership proof 1720 against the Merkle root in the asset-set commitment Merkle root 1700, confirming that the asset attempting to perform the action is indeed part of the accepted asset set. Second, it verifies projected parameters by checking the projected parameter commitment 1730, ensuring that the parameters of the invoked operation match the committed projected values. The runtime enforcement gate 1750 produces a verification result 1760 based on these checks.

The verification result 1760 determines the outcome of the action invocation 1740. If both membership and parameter conformance verification succeed, a permit operation 1762 allows the requested operation to proceed to the protected engine operations. If either verification fails, a deny operation 1764 blocks the requested operation, preventing unauthorized assets or parameter-tampered operations from executing.

This architecture provides significant technical advantages for runtime efficiency. By utilizing Merkle proofs, the system enables verification of individual asset usage without requiring transmission or storage of the entire asset list at each enforcement gate. The logarithmic complexity of Merkle proof verification ensures that even large asset sets can be efficiently validated. Furthermore, by combining membership verification with parameter conformance checking in a single operation, the runtime enforcement gate 1750 can simultaneously confirm both that an asset is authorized and that its operational parameters have not been tampered with since acceptance. This dual verification capability strengthens the security guarantees of the enforcement framework while maintaining computational efficiency during runtime operations.

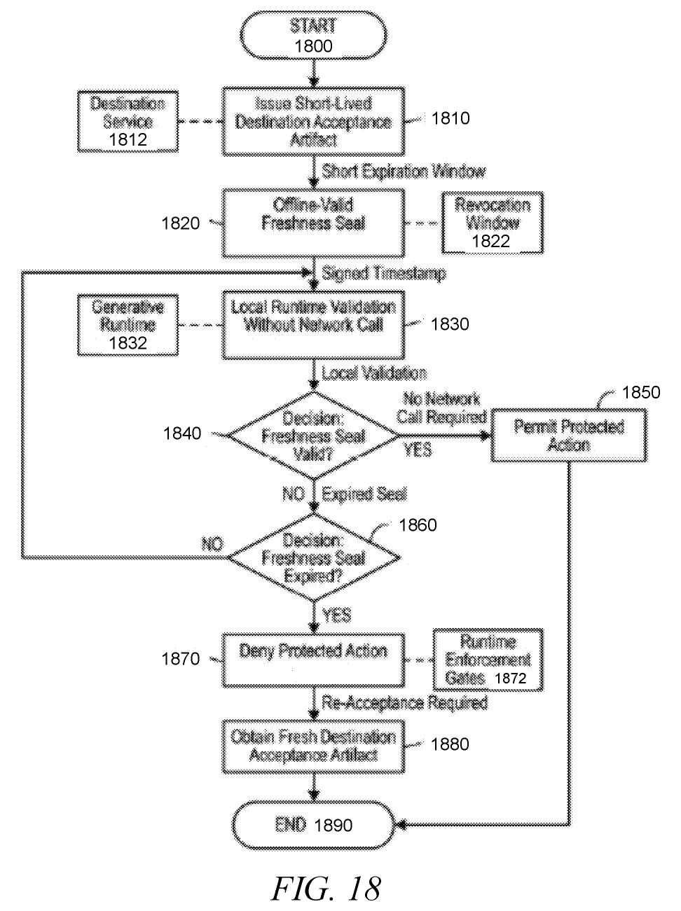

Referring now to FIG. 18, a method for offline or intermittent connectivity is illustrated. In general, support gameplay scenarios where a continuous connection to a central service is not possible, a destination may issue short-lived acceptance artifacts, such as the short-lived destination acceptance artifact 1810, that may contain offline-valid freshness seals, such as the offline-valid freshness seal 1820. These seals, which may include a signed timestamp with a short revocation window 1822, allow a generative runtime 1832 to validate the DAA locally without a network call, at step 1830. Revocation of permissions can be enforced simply via the seal's expiration. Once the seal expires, the runtime enforcement gates 1872 can deny protected actions, e.g., at step 1870, until a new, fresh DAA is obtained at step 1880.

Referring to FIG. 18 in greater detail, the flowchart illustrates a method for offline or intermittently connected acceptance using short-lived freshness seals and revocation windows. The method begins at step 1800, representing the start of the offline acceptance process. A destination service 1812 issues a short-lived destination acceptance artifact 1810. This artifact is configured with a short expiration window to limit the duration during which it can be used without network verification.

The method proceeds generating an offline-valid freshness seal 1820 associated with the destination acceptance artifact. The offline-valid freshness seal 1820 includes a revocation window 1822, which defines the temporal bounds within which the seal remains valid. The revocation window 1822 may be implemented as a signed timestamp that cryptographically binds the seal to a specific time period, enabling local validation without requiring real-time communication with a central authority.

At step 1830, a generative runtime 1832 performs local runtime validation of the destination acceptance artifact without requiring a network call. The generative runtime 1832 examines the offline-valid freshness seal 1820 and verifies that the current time falls within the revocation window 1822. This local validation capability enables gameplay scenarios in environments with intermittent or unavailable network connectivity.

The method then proceeds to a decision at step 1840, which determines whether the freshness seal is valid. This decision evaluates whether the seal's cryptographic signature is correct and whether the current time remains within the revocation window 1822. If the freshness seal is determined to be valid (YES branch), no network call is required and the method proceeds to step 1850, where the protected action is permitted. The user can continue to perform operations governed by the destination acceptance artifact without interruption.

If the freshness seal is determined to be invalid (NO branch), indicating a potential issue with the seal, the method proceeds to a decision at step 1860, which specifically determines whether the freshness seal has expired. If the freshness seal has not expired (NO branch), indicating that the invalidity stems from a reason other than expiration, the method returns to the decision at step 1840 for re-evaluation.

If the freshness seal has expired (YES branch), the method proceeds to step 1870, where the protected action is denied by runtime enforcement gates 1872. The runtime enforcement gates 1872 block any operations that require a valid destination acceptance artifact, preventing unauthorized actions from proceeding after the seal's validity period has elapsed.

Following the denial at step 1870, the method continues to step 1880, where a fresh destination acceptance artifact is obtained. This re-acceptance process requires network connectivity to communicate with the destination service 1812 and obtain a new artifact with a current freshness seal. The method concludes at step 1890, representing the end of the offline acceptance process.

This architecture provides several technical advantages for scenarios involving intermittent connectivity. By issuing short-lived acceptance artifacts with offline-valid freshness seals, the system enables continued operation during network outages while maintaining security through temporal bounds on artifact validity. The revocation window 1822 provides a mechanism for enforcing revocation without requiring real-time network communication, as permissions are automatically revoked upon seal expiration. This approach balances the need for offline functionality with the security requirement of limiting the duration during which potentially revoked permissions remain effective.

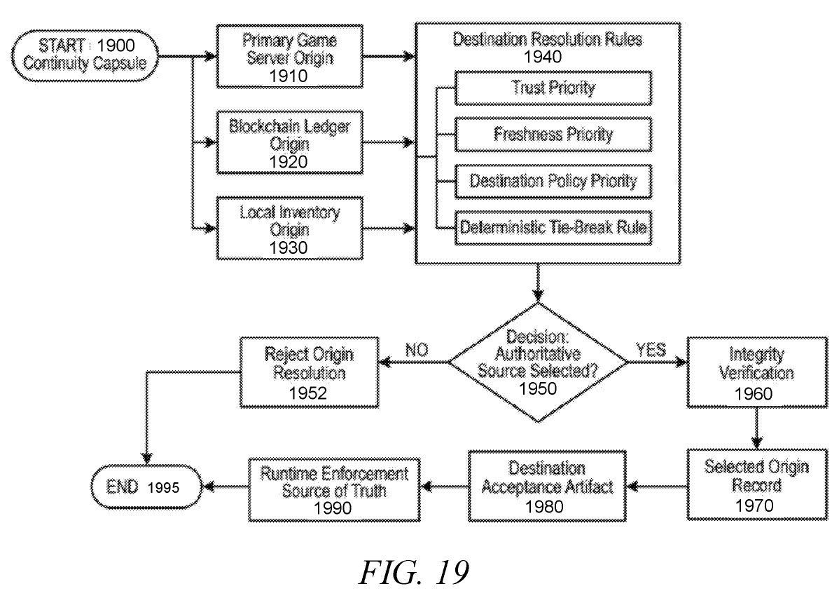

Referring now to FIG. 19, a process for multi-origin resolution is shown. In general, at start 1900, a continuity capsule may be configured to reference multiple potential origin sources for a user's identity or assets (e.g., a primary game server origin 1910, a blockchain ledger origin 1920, a user's local inventory origin 1930). When presented with such a continuity capsule, a destination system can resolve and select an authoritative source deterministically according to a set of destination resolution rules 1940. These destination resolution rules 1940 may prioritize sources based on trust, freshness, or destination policy. At decision 1950, if an authoritative source is selected, then a selected origin record 1970 of the selected origin or origins can be recorded in the DAA 1980 to ensure that all subsequent runtime enforcement is performed against the correct, deterministically chosen source of truth 1990.

Referring to FIG. 19 in greater detail, the flowchart illustrates a multi-origin identity and asset resolution process with destination-deterministic selection and integrity verification. The process begins at start 1900, identified as a START Continuity Capsule, where a continuity capsule may be received that may reference multiple potential origin sources for a user's identity or assets.

The process then proceeds to evaluate three potential origin sources. A Primary Game Server Origin 1910 may serve as the primary authoritative source for identity or asset data maintained by a game operator. A Blockchain Ledger Origin 1920 may provide a decentralized and immutable source for identity or asset resolution, particularly useful for assets with on-chain ownership records. A Local Inventory Origin 1930 may serve as a locally cached or stored source for the user's assets or identity information.

Each of these origin sources feeds into Destination Resolution Rules 1940. These rules include Trust Priority, which ranks sources based on their trustworthiness as determined by the destination; Freshness Priority, which prioritizes sources with the most recent data; Destination Policy Priority, which applies destination-specific preferences for source selection; and Deterministic Tie-Break Rule, which provides a consistent mechanism for resolving conflicts when multiple sources have equal priority. These rules collectively determine how the destination system selects an authoritative source from among the multiple origins.

The process then moves to decision 1950, a decision point labeled Decision: Authoritative Source Selected?, which determines whether an authoritative source has been successfully identified based on the resolution rules. If the decision 1950 results in NO, the process proceeds to step 1952, Reject Origin Resolution, indicating that the origin resolution has failed, and the continuity capsule cannot be accepted for the destination context.

If the decision 1950 results in YES, the process proceeds to step 1960, Integrity Verification, where the selected origin undergoes verification to ensure data integrity. This verification may include cryptographic signature checks, hash validation, or other integrity mechanisms appropriate to the selected origin type.

Following successful integrity verification, the process moves to selected origin record 1970, where the selected origin or origins are recorded. This record documents which source was chosen and the basis for that selection. The process then continues to Destination Acceptance Artifact 1980, where the selected origin record is incorporated into the destination acceptance artifact. By embedding the origin selection within the artifact, the system ensures that all subsequent enforcement operations reference the same authoritative source.

Next, the process proceeds to source of truth 1990, Runtime Enforcement Source of Truth, which establishes the verified and selected origin as the authoritative source for all subsequent runtime enforcement operations. This binding ensures consistency throughout the session, preventing conflicts that could arise from referencing different sources at different times.

The process concludes at step 1995, labeled END, indicating completion of the multi-origin resolution process. This architecture ensures that when a continuity capsule references multiple potential origins, the destination system can deterministically and verifiably select an authoritative source, and that this selection is recorded and enforced throughout the runtime session.

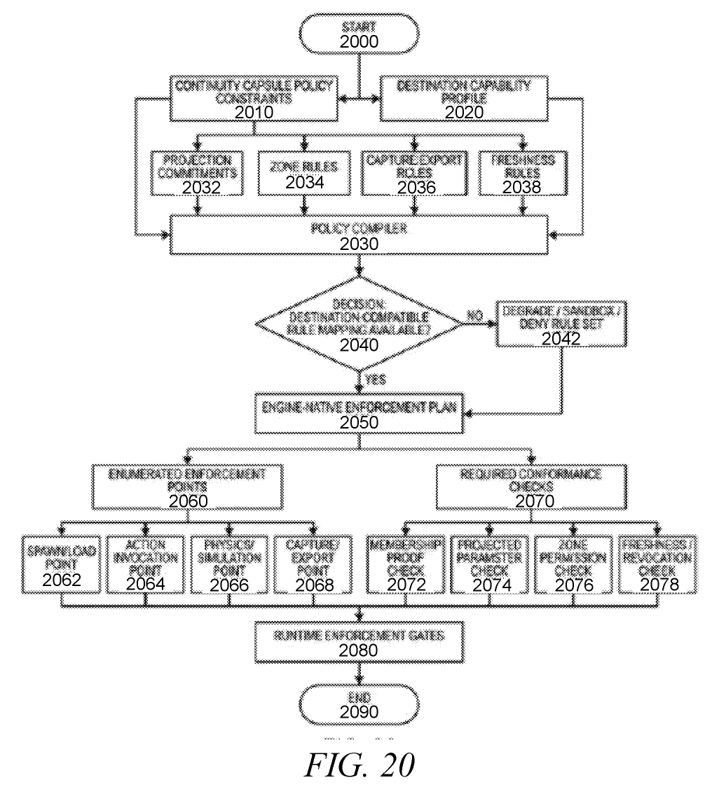

Referring now to FIG. 20, a policy compilation process is illustrated. In general, high-level policy constraints contained within a continuity capsule or a destination's own rules may be compiled into an engine-native enforcement plan 2050. The compilation process transforms declarative rules into an executable plan that enumerates the specific enumerated enforcement points 2060 (i.e., which runtime gates are required), the required conformance checks 2070 to be performed at each gate, and any fallback behaviors (e.g., which substitute asset to use). This turns abstract policy into concrete, executable runtime controls that are more efficient and less prone to interpretation errors than evaluating static metadata at runtime.

Referring to FIG. 20 in greater detail, the flowchart illustrates a policy compilation process that produces an engine-native enforcement plan enumerating enforcement points and required checks. The process begins at start 2000 and receives inputs from two primary sources: continuity capsule policy constraints 2010 and destination capability profile 2020. The continuity capsule policy constraints 2010 contain the high-level policy rules associated with the portable identity and its assets, while the destination capability profile 2020 provides the destination's own rules and capability definitions.

These inputs feed into policy compiler 2030, which processes the high-level policy information and transforms it into executable enforcement instructions. The policy compiler 2030 receives and processes several types of rules including projection commitments 2032, which define the committed projected states of assets; zone rules 2034, which specify location-based policy variations; capture/export rules 2036, which govern content capture and export permissions; and freshness rules 2038, which define temporal validity requirements.

Following compilation, the process reaches decision 2040, which evaluates whether a destination-compatible rule mapping is available. This decision determines whether the policy constraints from the continuity capsule can be successfully mapped to the destination's enforcement capabilities. If the decision 2040 determines that no compatible mapping is available (No branch), the process proceeds to degrade/sandbox/deny rule set 2042, which handles cases where full compatibility cannot be achieved. The degrade/sandbox/deny rule set 2042 specifies fallback behaviors, such as which substitute assets to use or which capabilities to restrict.

If the decision 2040 determines that a compatible mapping is available (Yes branch), the process proceeds to generate engine-native enforcement plan 2050. The engine-native enforcement plan 2050 represents the compiled output that transforms abstract policy into concrete, executable runtime controls.

The engine-native enforcement plan 2050 produces two categories of outputs. The first category is enumerated enforcement points 2060, which specifies the locations within the runtime where enforcement occurs. These enumerated enforcement points 2060 include spawn/load point 2062, which governs character spawning and asset loading operations; action invocation point 2064, which controls the execution of character actions and abilities; physics/simulation point 2066, which manages physics interactions and simulation updates; and capture/export point 2068, which regulates content capture and export operations.

The second category is required conformance checks 2070, which specifies the validation operations to be performed at each enforcement point. These required conformance checks 2070 include membership proof check 2072, which verifies that an asset belongs to the accepted asset set; projected parameter check 2074, which confirms that operation parameters conform to committed projected values; zone permission check 2076, which validates that the current zone permits the requested operation; and freshness/revocation check 2078, which ensures that the acceptance artifact remains temporally valid and has not been revoked.

Both the enumerated enforcement points 2060 and the required conformance checks 2070 feed into runtime enforcement gates 2080, where the compiled policy is executed during runtime operations. The runtime enforcement gates 2080 apply the specified conformance checks at each enumerated enforcement point, ensuring that all protected operations are validated against the compiled policy before execution proceeds. The process concludes at end 2090.

This policy compilation architecture provides several technical advantages over evaluating static metadata at runtime. By pre-compiling declarative policy rules into an executable enforcement plan, the system reduces runtime overhead and eliminates interpretation ambiguity. The enumeration of specific enforcement points ensures that all relevant gates are identified and configured before runtime operations begin. The specification of required conformance checks at each gate provides a deterministic and efficient validation process. Furthermore, the inclusion of fallback behaviors through the degrade/sandbox/deny rule set 2042 ensures graceful handling of incompatibility scenarios while maintaining security guarantees.

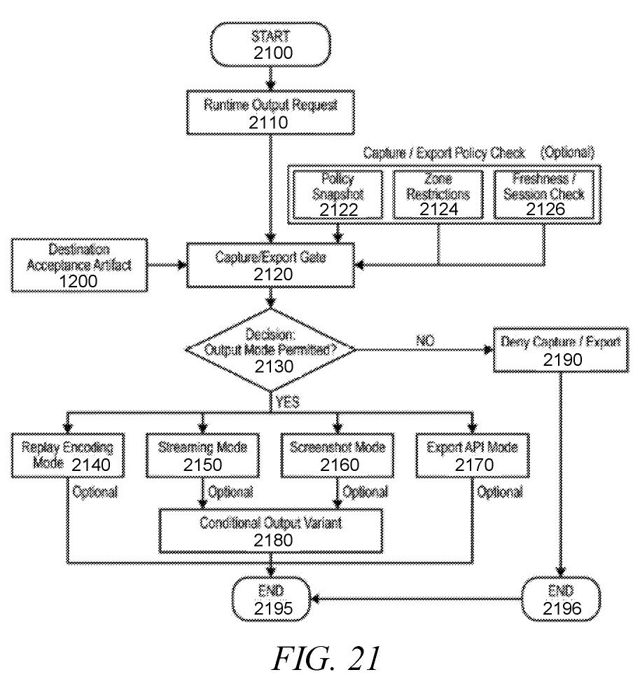

Referring now to FIG. 21, a control flow for capture and export controls is depicted. Using the illustrated process, a DAA's capture and export restrictions can be enforced at the entry points of a capture subsystem. For example, when a user issues a runtime output request, such as an attempt to initiate a screen recording or stream, the capture/export gate 2120 can first validate the DAA 1200. If at decision 2130 the DAA's policy constraints prohibit streaming or replay export, the capture/export gate 2120 can deny capture/export at step 2190, e.g., by blocking API calls for stream encoding or replay data export. However, the same policy might permit certain actions such as a simple screenshot, in which case the capture/export gate 2120 can enable, e.g., a screenshot mode 2160 that allows the specific permitted operation to proceed.

Referring to FIG. 21 in greater detail, the flowchart illustrates a capture/export control flow wherein acceptance artifacts gate replay encoding, streaming, screenshot modes, and export APIs. The process begins at step 2100, which represents the start of the capture/export control flow. At step 2110, a runtime output request is received from a user or system component. This request may represent an attempt to initiate screen recording, live streaming, screenshot capture, or data export operations.

The process proceeds to capture/export gate 2120. The capture/export gate receives input from the DAA 1200 and performs validation against the artifact's policy constraints. Associated with the capture/export gate 2120 are optional policy check operations including a policy snapshot step 2122, which retrieves the applicable capture/export policy from the DAA 1200; a zone restrictions step 2124, which evaluates whether the current zone permits the requested capture or export operation; and a freshness/session check step 2126, which verifies that the acceptance artifact remains temporally valid for the requested operation.

Following the policy evaluation, the process reaches decision 2130, which determines whether the requested output mode is permitted based on the policy constraints within the DAA 1200. This decision evaluates the specific type of capture or export operation against the permissions and restrictions defined in the artifact.

If the decision 2130 determines that the output mode is not permitted (NO branch), the process proceeds to step 2190, where the capture/export operation is denied. The denial at step 2190 may be implemented by blocking API calls for stream encoding, preventing replay data export, or otherwise inhibiting the unauthorized capture operation. The process then terminates at step 2196, representing the end of the control flow for denied operations.

If the decision 2130 determines that the output mode is permitted (YES branch), the process proceeds to one or more permitted output modes based on the specific permissions granted by the DAA 1200. These permitted output modes include replay encoding mode 2140, which enables recording of gameplay or session data for later playback; streaming mode 2150, which permits live transmission of content to external platforms or viewers; screenshot mode 2160, which allows capture of still images from the runtime environment; and export API mode 2170, which enables programmatic access to export functionality for authorized data extraction. Each of these output modes is marked as optional, as the specific permissions granted may vary based on the policy constraints within the DAA 1200.

Following the permitted output modes, the process proceeds to step 2180, which represents a conditional output variant. The conditional output variant at step 2180 handles any conditional processing of the output, such as applying watermarks, reducing resolution, or implementing other policy-mandated modifications to the captured or exported content. The process then terminates at step 2195, representing the end of the control flow for permitted operations.

This capture/export control architecture provides fine-grained enforcement of content capture and export restrictions at the runtime level. By validating capture and export requests against the DAA 1200 before permitting operations to proceed, the system ensures that intellectual property protections, privacy requirements, and content distribution policies are enforced consistently. The architecture enables destinations to permit certain capture operations, such as screenshots, while simultaneously restricting others, such as streaming or replay export, based on the specific policy constraints applicable to the portable identity and its associated assets.

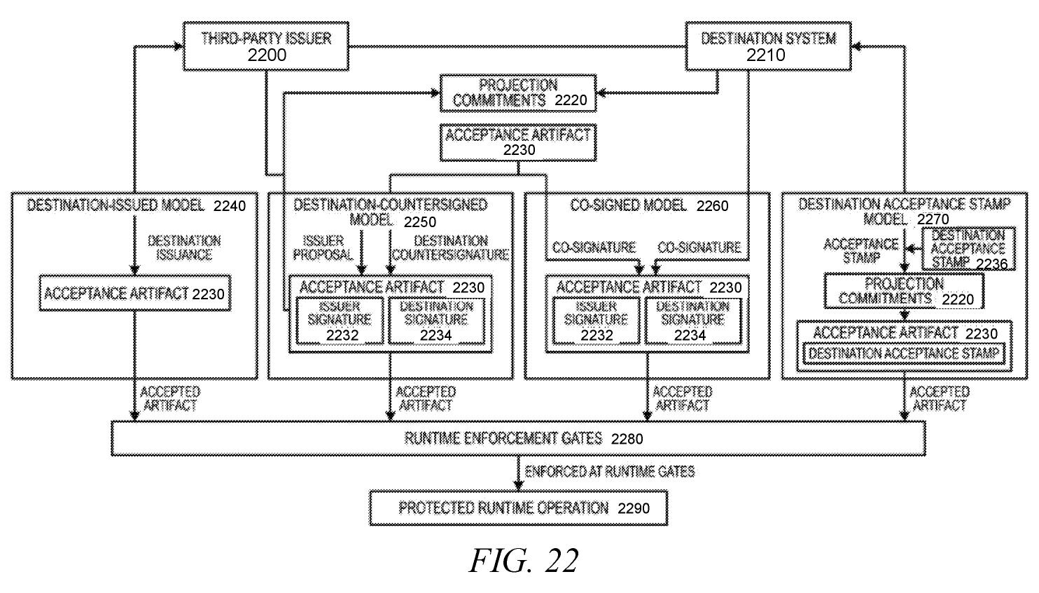

Referring now to FIG. 22, a multi-party acceptance embodiment is illustrated. To prevent schemes where a third-party asset issuer, such as third-party issuer 2200, might try to bypass a destination system's rules, the destination system 2210 can require multi-party agreement on an acceptance artifact 2230. Embodiments can include: a destination-issued model 2240 for artifacts that may be issued by the destination itself ("destination-issued"); a destination-countersigned model 2250 for artifacts issued by a third party but countersigned by the destination ("destination-countersigned"); a co-signed model 2260 for artifacts that are co-signed by both the destination and the issuer; or a destination acceptance stamp model 2270 for artifacts that include a specific "destination acceptance stamp" over the projection commitments. These structures ensure that so-called "issuer-only" schemes are still captured by the invention's logic, as they may still rely on the destination's acceptance and enforcement mechanisms to function.

Referring to FIG. 22 in greater detail, the diagram illustrates a multi-party acceptance embodiment where a destination and an issuer co-sign or countersign acceptance artifacts. The architecture addresses scenarios where third-party asset issuers might attempt to circumvent destination system rules by requiring multi-party agreement before acceptance artifacts become valid for runtime enforcement.

The third-party issuer 2200 represents an entity that creates or distributes portable assets, such as a game studio, content creator, or marketplace operator. The destination system 2210 represents the generative world instance or platform that will host the portable identity and its associated assets. Between these entities, projection commitments 2220 flow from the third-party issuer 2200 toward the destination system 2210, representing the committed projected states of assets that have been evaluated for destination compatibility.

The acceptance artifact 2230 serves as the central data structure that binds the various signatures and commitments together. Depending on the model employed, the acceptance artifact 2230 may include an issuer signature 2232, a destination signature 2234, or a destination acceptance stamp 2236. These cryptographic elements provide authentication and non-repudiation for the acceptance process.

The destination-issued model 2240 represents the most restrictive approach, wherein the acceptance artifact 2230 may be issued directly by the destination system 2210 through destination issuance. In this model, the destination system 2210 maintains complete control over the acceptance process, and no third-party signatures are required or recognized. This model is appropriate for destinations that require maximum control over which assets may operate within their environment.

The destination-countersigned model 2250 involves an issuer proposal from the third-party issuer 2200 that receives a destination countersignature from the destination system 2210. The resulting acceptance artifact 2230 contains both an issuer signature 2232 and a destination signature 2234. This model allows third-party issuers to initiate the acceptance process while ensuring that the destination system 2210 retains approval authority through its countersignature requirement.

The co-signed model 2260 requires simultaneous agreement from both parties, with a co-signature from the third-party issuer 2200 and a co-signature from the destination system 2210. The resulting acceptance artifact 2230 includes both an issuer signature 2232 and a destination signature 2234. This model establishes a bilateral agreement structure where neither party can unilaterally create a valid acceptance artifact.

The destination acceptance stamp model 2270 incorporates an acceptance stamp from the third-party issuer 2200 combined with a destination acceptance stamp 2236 from the destination system 2210. The projection commitments 2220 are included within this structure to produce an acceptance artifact 2230 that contains the destination acceptance stamp. This model allows the destination system 2210 to endorse specific projection commitments without requiring a full signature over the entire artifact.

Each of the four models produces an accepted artifact that flows into runtime enforcement gates 2280. The runtime enforcement gates 2280 validate the accepted artifacts according to the specifications of the applicable model before permitting any protected runtime operation 2290 to proceed. This enforcement ensures that regardless of which model generates the acceptance artifact, the artifact may satisfy the destination's multi-party specifications before protected operations can execute.

This multi-party architecture provides several technical advantages. By including destination involvement in the acceptance process, the system prevents third-party issuers from creating acceptance artifacts that bypass destination policies. The multiple model options provide flexibility for different trust relationships and operational specifications. Furthermore, the integration with runtime enforcement gates 2280 ensures that multi-party specifications are enforced consistently throughout the runtime session, not merely at initial acceptance.

### State-Drift Re-Evaluation and Dynamic Re-Acceptance

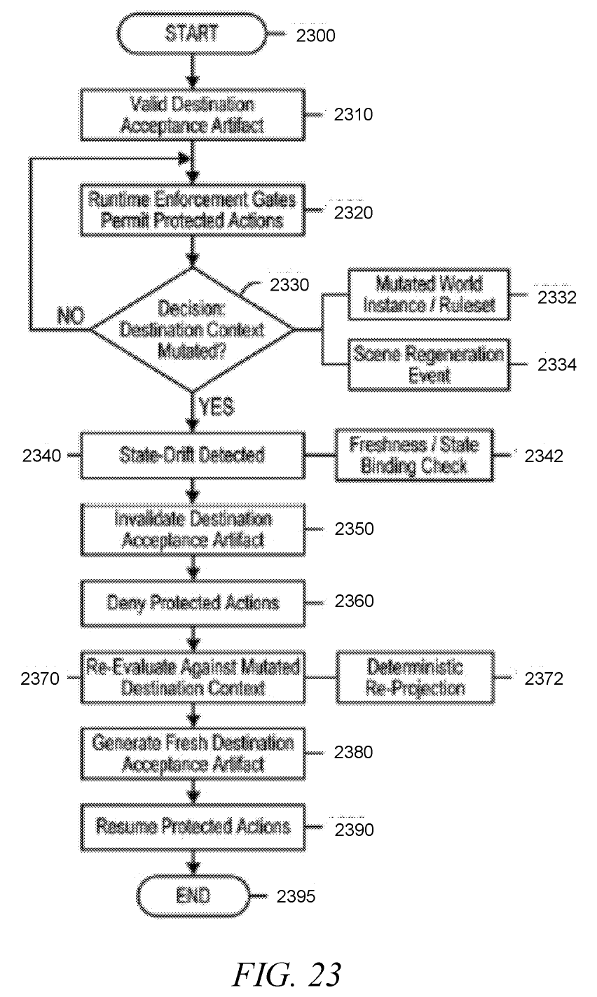

Referring now to FIG. 23, another aspect of the present invention is its ability to handle dynamic environments where the destination context can change mid-session. In general, the validity of a destination acceptance artifact can be tied not only to a temporal freshness field but also to the state of the world instance to which it was issued. If a destination context mutates after initial acceptance—for example, if the ruleset evolves or the scene regenerates—a previously issued DAA may become invalid. This "state-drift" can invalidate the DAA. Upon such invalidation, the framework can trigger a dynamic re-acceptance cycle. The runtime enforcement gates will deny protected actions until the asset undergoes a fresh evaluation against the new, mutated destination context, resulting in the issuance of a new DAA. This re-evaluation loop ensures asset behavior remains compliant and conformant.

Referring to FIG. 23 in greater detail, the flowchart illustrates a method for state-drift re-evaluation and dynamic re-acceptance. The method begins at step 2300, which represents the start of the state-drift re-evaluation process. At step 2310, a valid destination acceptance artifact is present within the system, indicating that the portable identity and its associated assets have been previously accepted for operation within the generative world instance.

The process proceeds to step 2320, where runtime enforcement gates permit protected actions based on the valid destination acceptance artifact. During this phase, the system operates normally, with the runtime enforcement gates validating operations against the cryptographic commitments within the existing artifact.

At step 2330, a decision is made to determine whether the destination context has mutated. This decision evaluates whether the generative world instance has undergone changes that could affect the validity of the existing destination acceptance artifact. Such mutations may include changes to the ruleset, modifications to simulation parameters, or alterations to policy constraints.

If the decision at step 2330 determines that the destination context has not mutated (NO branch), the process continues with the permitted protected actions at step 2320, maintaining normal operation under the existing destination acceptance artifact.

If the decision at step 2330 determines that the destination context has mutated (YES branch), the process identifies the nature of the mutation. Step 2332 indicates that a mutated world instance or ruleset exists, representing changes to the underlying rules or parameters governing the destination. Step 2334 indicates that a scene regeneration event has occurred, representing a more substantial transformation of the destination environment.

The process then proceeds to step 2340, where state-drift is detected. State-drift refers to the divergence between the destination context as it existed when the destination acceptance artifact was issued and the current state of the destination context. At step 2342, a freshness or state binding check is performed to confirm that the existing destination acceptance artifact is no longer valid for the mutated destination context.

At step 2350, the destination acceptance artifact is invalidated. This invalidation reflects the determination that the cryptographic commitments and policy bindings within the existing artifact no longer correspond to the current state of the destination context.

The process continues to step 2360, where protected actions are denied. The runtime enforcement gates block any operations that require a valid destination acceptance artifact, preventing the portable identity and its associated assets from performing protected operations until re-acceptance is completed.

At step 2370, the system re-evaluates the portable identity and its associated assets against the mutated destination context. This re-evaluation applies the same acceptance logic used during initial acceptance, but against the updated destination capability profile and policy constraints. At step 2372, a deterministic re-projection is performed, mapping the assets into destination-compatible representations based on the new destination context parameters.

The process proceeds to step 2380, where a fresh destination acceptance artifact is generated. This new artifact binds the continuity capsule to the mutated generative world instance and includes updated cryptographic commitments reflecting the re-projected asset states and current freshness information.

At step 2390, protected actions are resumed based on the newly generated destination acceptance artifact. The runtime enforcement gates now validate operations against the commitments within the fresh artifact, enabling the portable identity and its associated assets to operate within the mutated destination context.

The process concludes at step 2395, representing the end of the state-drift re-evaluation and dynamic re-acceptance method.

This dynamic re-acceptance architecture provides several technical advantages for generative environments. By binding destination acceptance artifacts not only to temporal freshness but also to the state of the destination context, the system ensures that acceptance remains valid for the specific conditions under which it was granted, without being valid under other conditions. The automatic detection of state-drift and triggering of re-acceptance cycles ensures that asset behavior remains compliant even when the destination context evolves mid-session. Furthermore, by denying protected actions during the re-acceptance process, the system prevents assets from operating under outdated acceptance conditions that may no longer reflect the destination's current policies or simulation constraints.

In accordance with the embodiments described herein, the present disclosure provides a system configured to generate a continuity capsule comprising an identity binding and an asset-set commitment associated with a plurality of assets. The system is further configured to obtain, for a dynamically instantiated generative world instance, a destination capability profile comprising one or more simulation envelopes. The system computes a deterministic projection that maps at least one asset of the plurality of assets into a destination-compatible representation. The system generates a destination acceptance artifact that binds the continuity capsule to the generative world instance and includes a cryptographic commitment to an output of the deterministic projection and a freshness field. The system enforces the destination acceptance artifact at a plurality of runtime enforcement gates in a generative runtime, wherein said enforcement comprises permitting an invocation of an operation when parameters of the invoked operation conform to the cryptographic commitment within a destination acceptance artifact that is valid for the generative world instance, and optionally only when parameters of the invoked operation conform to the cryptographic commitment within the destination acceptance artifact that is valid for the generative world instance.

The operation associated with the at least one asset may comprise at least one of equipping, firing, driving, trading, dropping, crafting, exporting, capturing, replay encoding, or saving state. The plurality of runtime enforcement gates comprise at least a spawn gate, an equip gate, an action invocation gate, and a physics simulation gate. Enforcing the destination acceptance artifact at the physics simulation gate includes verifying that a projectile parameter used in the physics simulation conforms to the cryptographic commitment.

In response to a state-drift in the generative world instance that invalidates the destination acceptance artifact, the instructions further cause the system to trigger a re-computation of the deterministic projection and generation of a new destination acceptance artifact. The continuity capsule may further comprise one or more policy constraints, and the instructions further cause the system to compile the policy constraints into an engine-native enforcement plan that enumerates the plurality of runtime enforcement gates and the conformance checks to be performed at each gate.

The deterministic projection comprises at least one of: clamping a parameter of the at least one asset into a simulation envelope, substituting the at least one asset with an asset from an equivalence set, or sandboxing usage of the at least one asset to a permitted zone. The simulation envelope comprises at least one of a mass bound, an impulse bound, a velocity bound, a collision complexity bound, or a damage model constraint. The asset-set commitment comprises a Merkle root over identifiers of the plurality of assets.

The destination capability profile includes a capture/export envelope, and the runtime enforcement gates include a capture gate configured to deny at least one of streaming or replay export when prohibited by policy constraints in the continuity capsule. The destination acceptance artifact may be co-signed by an issuer of the continuity capsule and a destination system associated with the generative world instance.

In accordance with further embodiments described herein, the present disclosure provides a computer-implemented method for destination-controlled runtime enforcement. The method comprises receiving a continuity capsule including an identity binding and an asset-set commitment associated with a plurality of assets. The method further comprises obtaining, for a dynamically instantiated generative world instance, a destination capability profile comprising one or more simulation envelopes. The method comprises deterministically projecting at least one asset referenced by the asset-set commitment into a destination-compatible asset state. The method further comprises issuing a destination acceptance artifact binding the continuity capsule to the generative world instance and including a cryptographic commitment to the destination-compatible asset state and a freshness field. The method comprises gating a runtime operation associated with the at least one asset at an action invocation point in a generative runtime, wherein said gating is based on verifying that parameters of the runtime operation conform to the cryptographic commitment within a destination acceptance artifact that is valid for the generative world instance.

The runtime operation may comprise driving a vehicle, and the simulation envelope includes a maximum speed or collision mass bound. This enables destinations to enforce vehicle-specific constraints that ensure portable vehicles operate within the destination's physics parameters, preventing vehicles from exceeding speed limits or exhibiting mass characteristics that would disrupt the simulation.

The method may further comprise denying the runtime operation when the destination acceptance artifact is stale based on the freshness field. This temporal validation ensures that acceptance artifacts cannot be used indefinitely, leading to periodic re-validation to maintain security and compliance with current destination policies.

In response to a state-drift in the generative world instance, the method may further comprise re-computing the deterministic projection and issuing a new destination acceptance artifact. This dynamic re-acceptance capability ensures that portable assets remain compliant even when the destination context mutates mid-session, such as when rulesets evolve or scenes regenerate.

The continuity capsule may further comprise one or more policy constraints, and the method may further comprise compiling the policy constraints into an engine-native enforcement plan that enumerates a plurality of action invocation points and the conformance checks to be performed. This compilation transforms declarative policy rules into concrete, executable runtime controls that are more efficient than evaluating static metadata at runtime.

Deterministically projecting may comprise clamping a parameter of the at least one asset into one of the one or more simulation envelopes. This clamping operation ensures that asset parameters such as mass, velocity, or damage values are constrained to fall within the bounds defined by the destination's simulation constraints.

Deterministically projecting may alternatively or additionally comprise selecting a substitute asset from an equivalence set according to a deterministic ordering. When a primary asset is incompatible with a destination, the system can deterministically select a substitute from a predefined set of permitted alternatives, ensuring consistent and predictable fallback behavior.

The asset-set commitment may comprise a Merkle root, and gating the runtime operation may further comprise receiving an asset membership proof for the at least one asset and verifying the asset membership proof against the Merkle root. This Merkle-based verification enables efficient runtime validation of individual asset usage without requiring transmission of the entire asset list, reducing verification overhead during runtime operations.

The destination capability profile may specify one or more policy zones, and the method may further comprise permitting the at least one asset to be visually rendered in a restricted policy zone while denying an invocation of a functional operation associated with the asset. This zone-based enforcement enables fine-grained control where assets may exist visually in restricted zones while their functional capabilities are selectively disabled based on the current zone context.

The method may further comprise generating a transition intent commitment binding a prior world instance identifier to a destination world instance identifier, and issuing the destination acceptance artifact based at least in part on the transition intent commitment. This transition mechanism enables secure cross-instance continuity by establishing a cryptographic handshake between prior and destination world instances.

The continuity capsule may reference multiple sources for the at least one asset, and the method may further comprise deterministically selecting an asset source according to a predefined rule and recording the selected asset source in the destination acceptance artifact. This multi-origin resolution ensures that when assets may originate from multiple sources, the system deterministically selects an authoritative source and records this selection for consistent runtime enforcement.

The freshness field may comprise a short-lived freshness seal for offline validation, and gating the runtime operation may include denying the operation after the freshness seal expires. This offline validation capability enables gameplay scenarios where continuous network connectivity is unavailable, while still enforcing revocation through seal expiration.

The foregoing descriptions of specific embodiments of the present disclosure have been presented for purposes of illustration and description. Those are not intended to be exhaustive or to limit the present disclosure to the precise forms disclosed, and obviously many modifications and variations are possible in light of the above teaching. The exemplary embodiments have been chosen and described in order to best explain the principles of the present disclosure and its practical applications, to thereby enable others skilled in the art to best utilize the present disclosure and various embodiments with various modifications as are suited to the particular use contemplated. Modifications to embodiments of the present disclosure described in the foregoing are possible without departing from the scope of the present disclosure as defined by the accompanying claims.

What is claimed is:

1. A system comprising one or more processors and memory storing instructions that, when executed, cause the system to:
generate a continuity capsule comprising an identity binding and an asset-set commitment associated with a plurality of assets;
obtain, for a dynamically instantiated generative world instance, a destination capability profile comprising one or more simulation envelopes;
compute a deterministic projection that maps at least one asset of the plurality of assets into a destination-compatible representation;
generate a destination acceptance artifact that binds the continuity capsule to the generative world instance and includes a cryptographic commitment to an output of the deterministic projection and a freshness field; and
enforce the destination acceptance artifact at a plurality of runtime enforcement gates in a generative runtime, wherein said enforcement comprises permitting an invocation of an operation when parameters of the operation conform to the cryptographic commitment within a destination acceptance artifact that is valid for the generative world instance.

2. The system of claim 1, wherein the operation associated with the at least one asset comprises at least one of equipping, firing, driving, trading, dropping, crafting, exporting, capturing, replay encoding, or saving state.

3. The system of claim 1, wherein the plurality of runtime enforcement gates comprise at least a spawn gate, an equip gate, an action invocation gate, and a physics simulation gate.

4. The system of claim 3, wherein enforcing the destination acceptance artifact at the physics simulation gate includes verifying that a projectile parameter used in the physics simulation conforms to the cryptographic commitment.

5. The system of claim 1, wherein the instructions further cause the system to, in response to a state-drift in the generative world instance that invalidates the destination acceptance artifact, trigger a re-computation of the deterministic projection and generation of a new destination acceptance artifact.

6. The system of claim 1, wherein the continuity capsule further comprises one or more policy constraints, and wherein the instructions further cause the system to compile the policy constraints into an engine-native enforcement plan that enumerates the plurality of runtime enforcement gates and conformance checks to be performed at each gate.

7. The system of claim 1, wherein the deterministic projection comprises at least one of: clamping a parameter of the at least one asset into a simulation envelope, substituting the at least one asset with an asset from an equivalence set, or sandboxing usage of the at least one asset to a permitted zone.

8. The system of claim 7, wherein the simulation envelope comprises at least one of a mass bound, an impulse bound, a velocity bound, a collision complexity bound, or a damage model constraint.

9. The system of claim 1, wherein the asset-set commitment comprises a Merkle root over identifiers of the plurality of assets.

10. The system of claim 1, wherein the destination capability profile includes a capture/export envelope, and wherein the runtime enforcement gates include a capture gate configured to deny at least one of streaming or replay export when prohibited by policy constraints in the continuity capsule.

11. The system of claim 1, wherein the destination acceptance artifact is co-signed by an issuer of the continuity capsule and a destination system associated with the generative world instance.

12. A computer-implemented method comprising:
receiving a continuity capsule including an identity binding and an asset-set commitment associated with a plurality of assets;
obtaining, for a dynamically instantiated generative world instance, a destination capability profile comprising one or more simulation envelopes;
deterministically projecting at least one asset referenced by the asset-set commitment into a destination-compatible asset state;
issuing a destination acceptance artifact binding the continuity capsule to the generative world instance and including a cryptographic commitment to the destination-compatible asset state and a freshness field; and
gating a runtime operation associated with the at least one asset at an action invocation point in a generative runtime, wherein said gating is based on verifying that parameters of the runtime operation conform to the cryptographic commitment within a destination acceptance artifact that is valid for the generative world instance.

13. The method of claim 12, wherein the runtime operation comprises driving a vehicle, and the simulation envelope includes a maximum speed or collision mass bound.

14. The method of claim 12, further comprising denying the runtime operation when the destination acceptance artifact is stale based on the freshness field.

15. The method of claim 12, further comprising, in response to a state-drift in the generative world instance, re-computing the deterministic projection and issuing a new destination acceptance artifact.

16. The method of claim 12, wherein the continuity capsule further comprises one or more policy constraints, the method further comprising compiling the policy constraints into an engine-native enforcement plan that enumerates a plurality of action invocation points and conformance checks to be performed.

17. The method of claim 12, wherein deterministically projecting comprises clamping a parameter of the at least one asset into one of the one or more simulation envelopes.

18. The method of claim 12, wherein deterministically projecting comprises selecting a substitute asset from an equivalence set according to a deterministic ordering.

19. The method of claim 12, wherein the asset-set commitment comprises a Merkle root, and wherein gating the runtime operation further comprises: receiving an asset membership proof for the at least one asset; and verifying the asset membership proof against the Merkle root.

20. The method of claim 12, wherein the destination capability profile specifies one or more policy zones, the method further comprising permitting the at least one asset to be visually rendered in a restricted policy zone while denying an invocation of a functional operation associated with the asset.

21. The method of claim 12, further comprising generating a transition intent commitment binding a prior world instance identifier to a destination world instance identifier, and issuing the destination acceptance artifact based at least in part on the transition intent commitment.

22. The method of claim 12, wherein the continuity capsule references multiple sources for the at least one asset, the method further comprising deterministically selecting an asset source according to a predefined rule and recording the selected asset source in the destination acceptance artifact.

23. The method of claim 12, wherein the freshness field comprises a short-lived freshness seal for offline validation, and wherein gating the runtime operation includes denying the operation after the freshness seal expires.

24. A non-transitory computer-readable medium storing instructions that, when executed by one or more processors, cause the one or more processors to perform the method of claim 12.
